(19) United States
(12) Patent Application Publication
(10) Pub. No.: US 2025/0122319 A1
(43) Pub. Date: Apr. 17, 2025

(54) AUTONOMOUS SELF-HEALABLE AND MECHANICALLY ROBUST HYDROGEL AND TRIBOELECTRIC NANOGENERATOR COMPRISING THE SAME

(71) Applicant: City University of Hong Kong, Kowloon (HK)

(72) Inventors: Irum Firdous, Kowloon (HK); Muhammad Fahim, Kolwoon (HK); Walid Daoud, Kowloon (HK)

(21) Appl. No.: 18/485,454

(22) Filed: Oct. 12, 2023

(51) Int. Cl. C08F 265/06; C08J 3/075; H02N 1/04

(52) U.S. Cl. CPC C08F 265/06; C08J 3/075; H02N 1/04; C08J 2351/06

(57) ABSTRACT

A self-healable hydrogel of acrylic acid (AA) graft copolymerized with gum Arabic (GA) via ferric ions cross-linking. The GA is imparted as a cluster molecule that offers a diffusionless solvent independent non-bonding interaction in the hydrogel and mediate strong bonding interactions. Methods of fabricating the hydrogel and a triboelectric nanogenerator (TENG) are also described. Besides self-healing characteristics, the TENG device retains high output performance of ambient state, at aqueous and frozen states owing to availability of electrostatically triggered diffusionless interaction in all states.

### FIELD OF INVENTION

This invention relates to all-weather triboelectric generators, hydrogels used in such generators, and methods of making the hydrogels.

### BACKGROUND OF INVENTION

Soft materials with direct electronic control enable bioinspired intelligent devices and systems. These materials should have high ionic and electrical conductivity, together with high mechanical stability, and yet the ability to autonomously self-heal. Self-healing is a sought-after property for next-generation wearable electronics that imparts dynamicity into materials through molecular-level physical or chemical interactions triggered by intrinsic mechanisms or external stimuli. The high-pressure sensitivity, multi-interface structure, and radiation-initiated defects in smart electronic devices necessitate using materials with fast autonomous self-healing capability. However, the incorporation of autonomous self-healability combined with high mechanical stability in a single conductive soft material is very challenging, as improvement of one property tends to worsen the other properties. For example, fast autonomous self-healing requires non-bonding weak interactions while high mechanical strength and operational endurance require chemical bonding strong forces. Also, the electrical conductivity is high in semisolids as the matrix needs solvent to disperse the ions. Therefore, realizing this goal remains elusive due to sluggish dynamics of bonded ions.

Fast autonomous self-healability along with electrical conductivity at ambient conditions is very rare and only occurs in ionogels or wet hydrogels, which suffer from fluid puncturing and short-circuiting issues. Self-healability in solids is triggered by ionic or covalent interactions, which are slow and require external activation. Moreover, covalent and ionically linked structures have less charge retention and delocalization density, which limit their applicability in extended charge accumulation devices, such as triboelectric nanogenerators. The expeditious growth of self-healable multifunctional electronics poses a challenge on power devices to acquire fast autonomous self-healing of solids with efficient electrical recovery. However, realizing this goal remains elusive due to the sluggish dynamics of bonded ions.

A triboelectric nanogenerator is an electromechanical conversion technology based on the coupling of two static effects: contact electrification and electrostatic induction, which enable the device to harvest low-frequency dynamics. Briefly, when two materials with a certain difference in surface polarities are brought into contact, a charge transfer occurs, which diffuses in the bulk of the layers through either bonding, non-bonding or dipolar interactions followed by induction to conductive layers via the built-in potential of the electrode. The electrification layer builds a floating polarized interface with the induction layer, which acts as the source of diffused charges towards the collector layer through double layer formation. Owing to high polarizability, biocompatibility, flexibility, stretchability, ultraconformality, dry nature, and mechanical durability, polysiloxanes are often used as the negative electrification layer. The induction layer is usually formed by (i) anchoring percolated network of conductive materials, such as carbon paste, graphene, carbon nanotubes, and silver nanowires on a pre-strained elastomer substrate, and (ii) encapsulating ionic liquids, gels, or (iii) hydrogels. However, the polarized interface of such induction layers is unstable due to high sheet resistance, lower wettability of ionic liquids, and drying out of the hydrogel matrix. Hydrogels are soft stretchable hydrophilic polymeric networks swollen by water or aqueous ionic solution, of which resistivity increment with strain is orders of magnitude lower than percolated and liquid-based induction layers. The charges in hydrogels are screened from the electrification layer via dynamic secondary covalent or ionic interactions of ionic or conjugated charge carriers, which can also impart self-healing characteristics in the matrix. However, since hydrogel adhesion to the electrification layer and the activity of carriers are controlled by water content, reduction in hydration rate not only decreases the polarization interface but also screening of the charges from the electrification interface. Moreover, hydrogel, organogel, and conductive liquid-based induction layers, suffer from crystallization at freezing condition, and ions dilution in aqueous environment. Therefore, developing a solid-state fast autonomous self-healing hydrogel network independent of intrinsic water content and environmental conditions remains a challenge.

### SUMMARY OF INVENTION

Accordingly, the invention in one aspect provides a self-healable hydrogel, which contains an acrylic acid (AA) graft copolymerization with gum Arabic (GA), and ferric ions cross-linking the GA-grafted AA copolymer. The GA is imparted as a cluster molecule that mediates non-bonding diffusionless interaction in the hydrogel.

In some embodiments, the hydrogel contains intermolecular hydrogen bonding sites, intramolecular hydrogen bonding sites, non-bonding electron pairs, and dynamic covalent bonding sites.

In some embodiments, the hydrogel is adapted to be preserved at a temperature from −30° C. to 80° C.

In another aspect of the invention, there is provided a method of preparing a self-healable hydrogel. The method includes the steps of dissolving AA in deionized water, adding GA into the solution of the AA, adding ferric chloride hexahydrate as a cross-linker, adding ammonium persulfate into the solution, and heating the solution at 40° C. The GA has a weight ratio of no more than 12 wt. % with respect to the AA.

In some embodiments, the ferric chloride hexahydrate has a weight ratio of no more than 3 wt. % with respect to AA.

In another aspect of the invention, there is provided a triboelectric nanogenerator, which contains a self-healable hydrogel as mentioned above as an induction layer, an elastomer as an electrification layer encapsulating the hydrogel; and a tribopositive layer adapted to screen electrification charges to the elastomer.

In some embodiments, the elastomer is made of silicon rubber.

Embodiments of the invention thus provide stretchable, transparent, solid hydrogel networks of AA grafted with GA for autonomous healing. The self-healing hydrogel matrix is enriched with intermolecular, intramolecular hydrogen bonding sites, non-bonding electron pairs, and dynamic covalent bonding sites crosslinked via secondary ionic bonding. The combination of these overlapping interactions imparts ambient-environment autonomous self-healing of mechanical, optical, electrical properties and retention of the healing characteristics in wet and freezing (e.g. −30° C.) states. This diffusion-less approach of intrinsic switchable interaction is promising for robotics, sportswear, all weather prosthetics, cryogenics, and harsh weather power back-up applications. These characteristics have not been achieved by commercial wearables to date.

### BRIEF DESCRIPTION OF FIGURES

The foregoing and further features of the present invention will be apparent from the following description of embodiments which are provided by way of example only in connection with the accompanying figures, of which:

FIG. 1 is a process flow diagram of a one-pot synthetic route for preparing self-healing a hydrogel according to a first embodiment of the invention.

FIG. 2 shows a scheme of free radical polymerization of AA monomers in aqueous media with ferric crosslinking using ammonium per sulphate (APS) as a radical initiator and source of radicals.

FIG. 3 illustrates chemical structure of a hydrogel network according to one embodiment of the invention, along with bonding and non-bonding interactions in the matrix and their corresponding IR spectra of hydrogel.

FIG. 4 shows Fe³⁺ crosslinked deprotonated carboxylic functional groups of two GA units via divalent ionic interaction in the hydrogel network.

FIG. 5 shows IR spectra of a hydrogel with addition of various concentration of Fe³⁺.

FIG. 6 shows IR spectra of the hydrogel with and without copolymerization of GA.

FIG. 7a shows transmittance of a hydrogel network with different ratios of Fe³⁺ crosslinker.

FIG. 7b shows absorption spectra of the hydrogel network with different ratios of Fe³⁺ crosslinker.

FIG. 7c is a comparison of optical properties of hydrogel network, with and without GA grafting.

FIG. 7d is a comparison of mechanical properties of hydrogel network, with and without GA grafting.

FIG. 8 shows optical microscopic observation of ambient-condition self-healing process of cracks and cuts of a sample hydrogel layer made according to one embodiment of the invention. Digital photos of the self-healing process in aqueous and freezing (−30° C.) states are illustrated as indicated.

FIG. 9 is a field emission scanning electron microscopy (FESEM) image of the hydrogel layer after cutting and its energy-dispersive X-ray spectroscopy (EDS) elemental mapping during self-healing process.

FIG. 10 illustrates a stretchability test of the hydrogel layer. The inset shows stretched images, which indicate wrinkle formation in the hydrogel matrix above 450% stretching.

FIG. 11 depicts an optical transparency of the hydrogel layer after self-healing from several cuts.

FIG. 12 illustrates recovery of mechanical properties of the hydrogel layer at various healing durations.

FIG. 13 illustrates recovery of mechanical properties of the hydrogel layer in various media.

FIG. 14a illustrates error bars in the mechanical measurement of the hydrogel layer with a sample size of 5 each for healing recovery over time.

FIG. 14b illustrates error bars in the mechanical measurement of the hydrogel layer with a sample size of 5 each for healing in various media.

FIG. 15 illustrates the resistivity of various hydrogel layers before and after self-healing.

FIG. 16a illustrates the sample hydrogel layer in FIG. 8, with platinum wiring connected to the two-electrode system of the workstation.

FIGS. 16b, 16c, 16d, 16e and 16f are Nyquist plots of the hydrogel layer before and after self-healing for each sample as indicated.

FIG. 17 shows Axio imager A2m setup equipped with LTS120 temperature control stage for determining hydrogel behavior at extreme temperature conditions.

FIG. 18 shows characteristics of the hydrogel according to an embodiment of the invention as compared with prior art.

FIG. 19 depicts triboelectrification and electrostatic induction mechanism of a SHE-TENG (self-healable triboelectric nanogenerator) device according to an embodiment of the invention, after contacting tribopositive layer.

FIG. 20 shows role of induction layer in the SHE-TENG device towards duration and density of charge availability.

FIG. 21 shows output performance evaluation of the SHE-TENG device at various contact separation frequencies.

FIG. 22a shows the role of grafting GA with PAA in the SHE-TENG device by comparing the amount of charge transfer from ecoflex to hydrogel interface with Fe³⁺ crosslinked PAA without GA.

FIG. 22b shows the role of grafting GA with PAA in the SHE-TENG device by comparing the output voltage with Fe³⁺ crosslinked PAA without G.

FIG. 22c shows the role of grafting GA with PAA in the SHE-TENG device by comparing current at contact-separation frequency of 1 Hz with Fe³⁺ crosslinked PAA without GA.

FIG. 23a shows, in a method of fabricating the SHE-TENG layer according to one embodiment of the invention, the ecoflex layer preparation from 1:1 of part A & part B.

FIG. 23b shows that hydrogel is enclosed in ecoflex layers with VHB tape on the lower layer in the fabrication method.

FIG. 23c shows that the enclosed hydrogel is vacuum laminated to avoid air gaps in the fabrication method.

FIG. 23d shows that the exposed edges are sealed with freshly prepared ecoflex gel and dried in the fabrication method.

FIG. 24a shows a testing setup of SHE-TENG device against polyethylene foam and the output characteristics signals.

FIG. 24b shows transferred charges as outputted from a sample SHE-TENG device.

FIG. 24c shows open circuit potential as outputted from the SHE-TENG device.

FIG. 24d shows short circuit charge density as outputted from the SHE-TENG device.

FIG. 24e shows evaluation of output current of various SHE-TENG devices according to embodiments of the invention, at external load resistance ranging from 100Ω to 20Ω.

FIG. 24f shows power density of the various SHE-TENG devices according to maximum power theorem.

FIG. 24g shows durability of the sample SHE-TENG device as function of weight loss.

FIG. 24h shows performance deterioration of the sample SHE-TENG device with time.

FIG. 24i shows performance deterioration of the sample SHE-TENG device with full halves mechanical damage.

FIG. 25a shows stability of voltage output signals of the sample SHE-TENG device at consecutive contact separation cycles for 1000s.

FIG. 25b shows stability of current output signals of the sample SHE-TENG device at consecutive contact separation cycles for 1000s.

FIG. 25c shows reproducibility of device output (open circuit potential) of ten different SHE-TENG devices made.

FIG. 26a shows transferred charges from the sample SHE-TENG device via hand tapping of the device at ambient temperature.

FIG. 26b shows transferred charges from the sample SHE-TENG device via hand tapping of the device after storing the device for 24 h in deionized water.

FIG. 26c shows transferred charges from the sample SHE-TENG device via hand tapping of the device at −30° C.

FIG. 27 is a graph showing electrical output of the sample SHE-TENG device from hand tapping in ambient environment.

FIG. 27a illustrates the J_{SC} when the device is in ambient environment.

FIG. 27b illustrates the V_{OC} when the device is in ambient environment.

FIG. 27c illustrates the J_{SC} after storing the device for 24 h in DI water.

FIG. 27d illustrates the V_{OC} after storing the device for 24 h in DI water.

FIG. 27e shows the J_{SC} after storing the device for 24 h in −30° C. fridge followed by testing the output while placing the device on freezing steel cooling cubes.

FIG. 27f shows the V_{OC} after storing the device for 24 h in −30° C. fridge followed by testing the output while placing the device on freezing steel cooling cubes.

FIG. 27g shows a current profile of device against external load resistance ranging from 100Ω to 20Ω.

FIG. 27h shows current output at peak power density.

FIG. 27i shows corresponding power density.

FIG. 27j shows a comparison of the SHE-TENG output with reported self-healable liquid, semisolid, and solid state based single electrode devices.

FIG. 28 is a schematic of the SHE-TENG aqueous state performance evaluation setup.

FIG. 29 is an infrared mapping of the sample SHE-TENG device after 24 h storage at −30° C. and the measurements setup.

FIG. 30a shows the cycling stability of the sample SHE-TENG device in ambient environment.

FIG. 30b shows the cycling stability of the sample SHE-TENG device in aqueous state.

FIG. 30c shows the cycling stability of the sample SHE-TENG device in freezing state.

FIG. 31a shows cyclic differential scanning calorimetric analysis of hydrogel at a rate of 10° min-1 from 30° C. to −60° C.

FIG. 31b shows cyclic differential scanning calorimetric analysis of ecoflex elastomer at a rate of 10° min-1 from 30° C. to −60° C.

FIG. 32 shows a table of comparison of device performance of the sample SHE-TENG device with reported self-healable materials employed in TENG application.

FIG. 33a is a demonstration of human kinetic energy harvesting by the sample SHE-TENG device via one finger touching the SHE-TENG device.

FIG. 33b is a demonstration of human kinetic energy harvesting by the sample SHE-TENG device via two finger slight touching the SHE-TENG device.

FIG. 33c is a demonstration of human kinetic energy harvesting by SHE-TENG via one finger touching rolled SHE-TENG.

FIG. 33d shows output voltage response of the sample SHE-TENG device mounted on human index finger using ecoflex upon bending at various angles.

FIG. 33e illustrates the use of hydrogel film as a switch in the electronic circuit as indicated in the inset.

FIG. 33f shows the sample SHE-TENG device as a power source to charge Li—Cr 2032 battery by connecting the device with bridge rectifier to provide input to battery while simultaneously connected to Keithley for demonstrating charging status.

FIG. 34a shows stability of voltage output of the sample SHE-TENG device from finger bending at 90° before and after self-healing.

FIG. 34b shows stability of voltage output of the sample SHE-TENG device from finger bending at 90° over prolonged contact-separation cycling loops.

### DETAILED DESCRIPTION

Self-healing is a virtue of a material of regaining its chemical, optical, electrical, and morphological properties after deformation via extrinsic or intrinsic stimuli through reformation of covalent, ionic, dynamic/reversible bonds, or non-covalent supramolecular interactions. The energy required for covalent and ionic bonds-based healing is relatively high and is achieved through prolonged exposure to thermal electromagnetic waves irradiation, watering, or mechanical pressure. Reversible covalent or ionic bonds also known as dynamic bonds involving more than one active group for bond formation and can self-heal in a comparatively short-time exposure to stimuli or autonomously. Reversible non-covalent interactions include ion-ion interaction, ion dipole interaction, dipole-dipole interaction, H-bonding, π-π interactions, cation-π interactions, anion-π interactions, coordination, hydrophobic interactions, and Van Der Waals interactions.

Considering the high strength benefits of covalent, ionic interaction and fast low energy reformation of reversible non-covalent bond along with non-bonding interactions, in a first embodiment of the invention a hydrogel is designed by combining these two healing characteristics. Diffusion-less bonding and non-bonding, chemical, and electrostatic interactions are coupled by introducing hydrogen bonding cluster and non-bonding electrostatic centers in solids to accelerate ion dynamics via more delocalization centers that can switch healing reformations at various physical states. These diffusion-less intrinsic switchable bonding and nonbonding interactions, via graft polymerization of non-bonding cluster molecule to main chain of polyacrylic acid main chain, enable self-healing and hence energy harvesting capability in ambient, aqueous, and frozen states owing to universal charge delocalization and versatile dynamics of reformation interactions. The hydrogel as electrode layer attains electrical, mechanical, and morphological self-healing in only 5-10 seconds without any external stimuli.

In one example, a fabricated soft flexible stretchable triboelectric nanogenerator device contains highly polarizable, biocompatible, flexible, stretchable, ultra-conformable, dry natured, and mechanically durable polysiloxane negative electrification layer. The electrification layer further sandwiches a transparent, stretchable, hydrogel induction layer made of the hydrogel mentioned above, which not only electrostatically induce charges from polysiloxane but owing to its coupled bonding and non-bonding diffusionless charge transfer mechanism, it harvests triboelectrification energy in ambient, aqueous, and frozen states and hence is self-healable in all these states. The self-healable hydrogel renders the sample triboelectric nanogenerator made on contact with skin with a power density of 11.1 W m⁻² at a matching impedance as low as 9 MΩ, retaining 7.28 W m⁻² in aqueous and 7.04 W m⁻² frozen states, which outperforms all the reported self-healable induction devices. This diffusion-less approach of intrinsic switchable interaction is promising for robotics, sportswear, all weather prosthetics, cryogenics, and harsh weather power back-up applications.

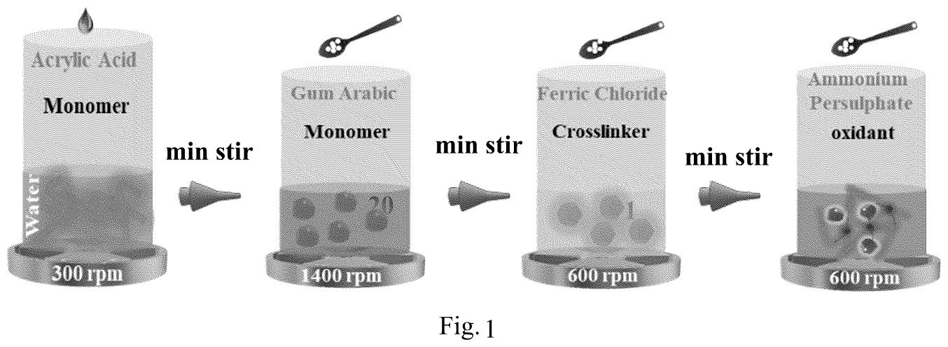

With detailed descriptions on the hydrogel, a self-healable hydrogel network with sufficient conductivity for fast charge induction is prepared by a method according to a second embodiment of the invention that utilizes free radical polymerization of AA monomers in aqueous media with APS initiator as schematically shown in FIG. 1. The method starts with dissolving AA in deionized water while the container is rotating at a speed of 300 rpm. The solution is thus stirred, and the duration is 2 minutes. Then, GA is added into the solution of the AA while the container is rotating at a speed of 1400 rpm. The solution is thus stirred, and the duration is 20 minutes. Next, the step is charging the solution using ferric chloride hexahydrate as a cross-linker, while the container is rotating at a speed of 600 rpm. The solution is thus stirred, and the duration is 1 minute. Next, the step is adding ammonium persulfate into the solution while the container is rotating at a speed of 600 rpm. Finally, the solution is heated for a predetermined time (not shown in FIG. 1).

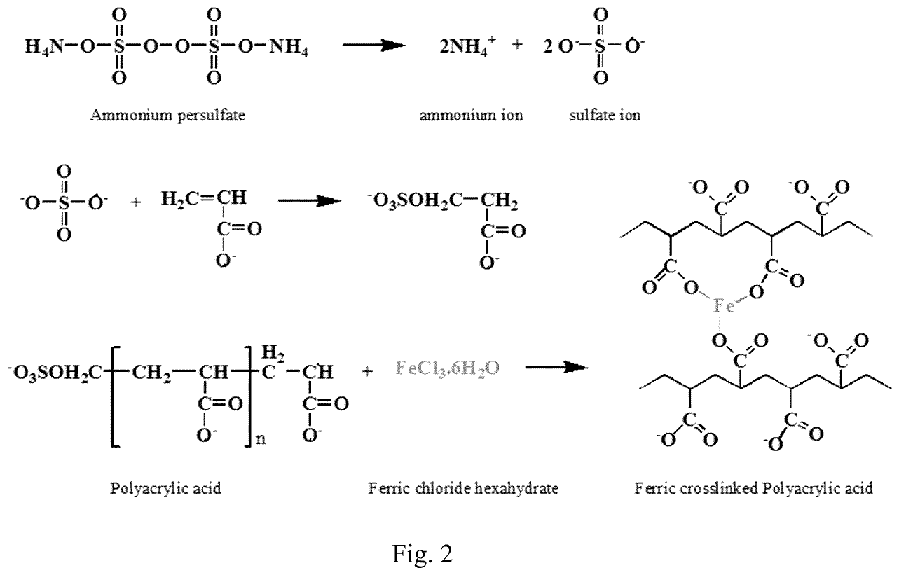

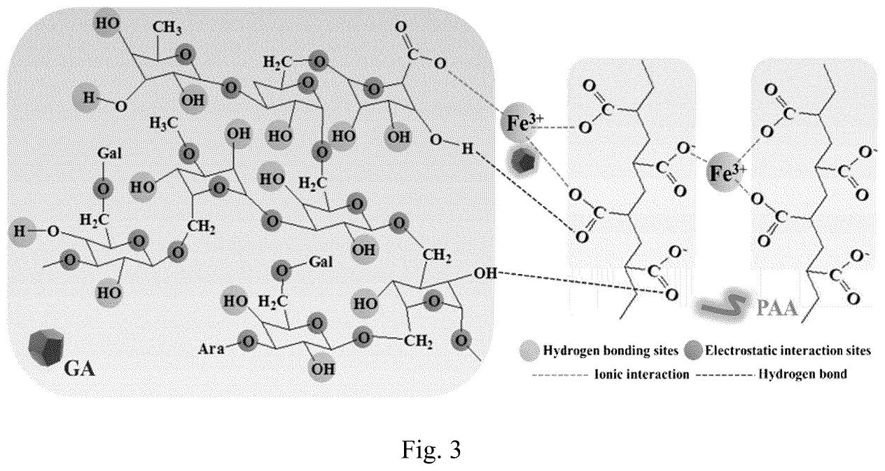

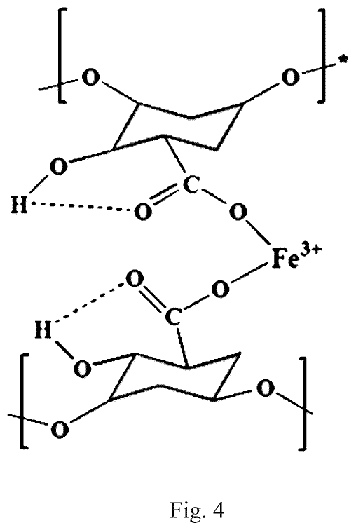

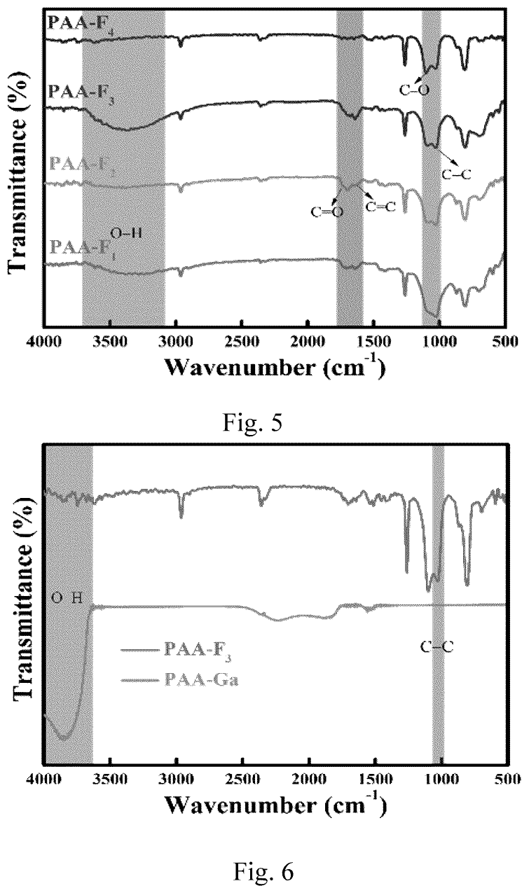

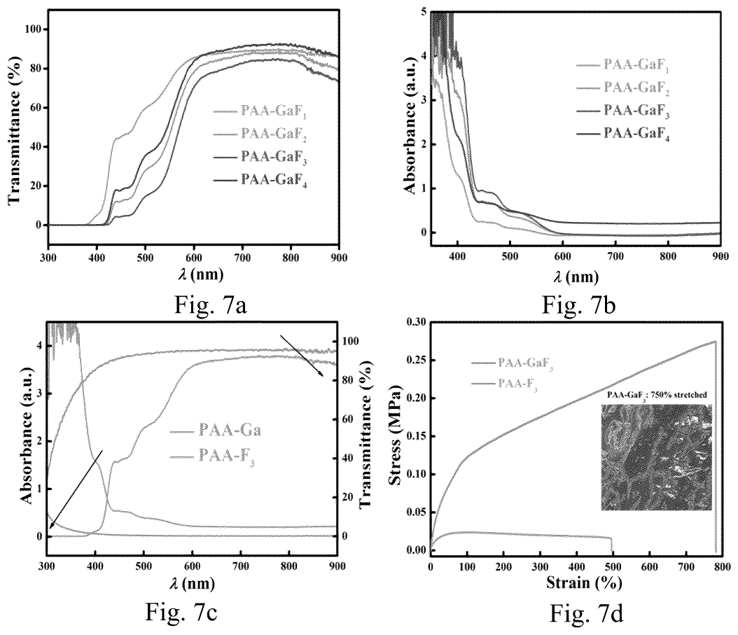

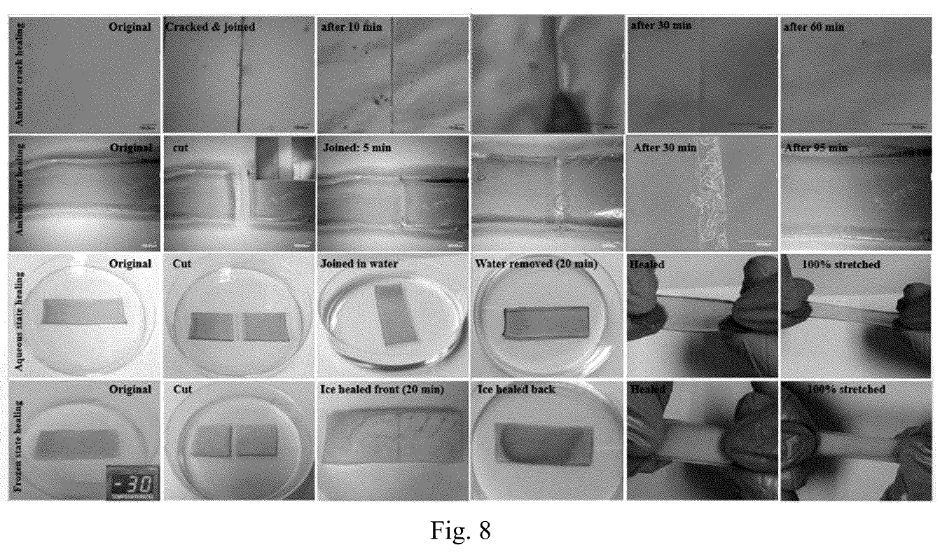

In the method above, a polysaccharide GA, containing 1, 3-linked β-D-galactopyranosyl units with galactose, rhamnose, glucuronic acid and arabinose residues, is grafted on AA backbone as a reservoir of hydrogen bonding. Both AA and GA are water-soluble and have carboxylic groups with low pKa values (AA=4.2, GA=4.4), which deprotonate easily in deionized water with solution pH of 6-7. The generated sulphate free radicals initiate the polymerization of AA (see FIG. 2), while the deprotonated carboxylic functional groups are crosslinked through Fe³⁺ ions forming mono, di, and tri ionic linked interactions between GA-AA, AA-AA, and GA-GA as shown in FIG. 3 and FIG. 4. Due to the difference in the electronegativity of hydrogen and oxygen, the hydroxyl groups of GA are partially charged and form hydrogen bonding with AA. The carbon bonded oxygen forms electrostatic interactions with Fe³⁺ through its lone pair electrons (n). The ionic coordination of Fe³⁺ carboxylic group dims the characteristic C═O IR peak of AA and GA at 1700 cm⁻¹ due to decrease in vibration intensity. However, the presence of free carboxylic groups contributes to the weak peak at 1700 cm⁻¹, which overlaps with the peak of C═C at 1646 cm⁻¹ being dipole sensitive and decreases with increasing concentration of Fe³⁺ (see FIG. 5). Also, the C—C peak at 1023 cm⁻¹ confirms the incorporation of Fe³⁺ in the PAA grafted Ga matrix. The wide peak at 3634-3980 cm⁻¹ (see FIG. 5) corresponding to the —OH stretching of GA is shifted to 3080-3690 cm⁻¹ (see FIG. 6) in PAA-GaF due to secondary hydrogen bonding and electrostatic interactions. With increasing Fe³⁺ concentration of (PAA-GaF₄), the peaks at 1700 cm⁻¹, 1646 cm⁻¹, and 3080-3690 cm⁻¹ disappeared as all the hydroxyl and deprotonated carboxylic groups are coordinated with Fe³⁺ through ionic and dynamic secondary electrostatic interaction. The inconsistency in the sharpness of 1646 cm⁻¹ band PAA-GaF₃ is due to the balance of Fe³⁺ concentration and dipole arrangement where the peak intensity is dipole sensitive. The reduced hydroxyl peak in PAA-GaF₂ is due to increased hydrogen bonding at the carboxyl end group compared to PAA-GaF₂ as depicted from the C—O band intensity. More details on band variation with Fe³⁺ concentration and Ga grafting are provided in Table 1. Moreover, the hydrogel has high transparency (>73%) in the range of 900-600 nm (see FIG. 7a) followed by characteristic peaks at 405 nm, 470 nm and 540 nm corresponding to n-δ* (Fe—O), n-n* (C—O), n-n* (C═O) transitions, respectively (see FIG. 7b). The PAA-Ga does not undergo any transition in the visible region (see FIG. 7c), but in the presence of Fe³⁺, the GA promoted transition at 446 nm is ascribed to n-δ* (Fe—O). Briefly, the hydrogel of polyacrylic acid grafted with GA and crosslinked with Fe³⁺ ions form ionic and hydrogen bonding via the active carboxylic groups of GA and AA. The long chain of acrylic acid coils up around GA and interacts via hydrogen bonding and with electrostatic sites, which strengthens the hydrogel and enhances stretchability via reducing entanglements compared to pristine PAA chain (see FIG. 7d).

TABLE 1
IR band assignment for PAA-GaF and PAA-Ga hydrogels.

| Band | | | |
|---|---|---|---|
| Position | Assignment | PAA-GaF | PAA-Ga |
| 3634- | —OH | | Free hydroxyl |
| 3980 cm⁻¹ | | | groups |
| 3080- | —OH | Secondary hydrogen bonding and | |
| 3690 cm⁻¹ | | electrostatic interactions saturate free | |
| | | hydroxyl which further diminishes with | |
| | | increasing concentration of Fe³⁺ | |
| 1700 cm⁻¹ | C═O | Free carboxylic groups decrease with | |
| | | increasing concentration of Fe³⁺ and Ga | |
| | | grafting | |
| 1646 cm⁻¹ | C═C | The secondary ionic bonding compels direct | |
| | | C═C | |
| | | (Intensity varies with dipole, dims in PAA- | |
| | | GaF4 due to saturation of mostly available | |
| | | hydrogen and electrostatic dipoles) | |
| 1100 cm⁻¹ | C—O | Carboxyl hydrogen bonding site | |
| 1023 cm⁻¹ | C—C | Bonding between PAA and GA via | |
| | | incorporation of Fe³⁺ | |

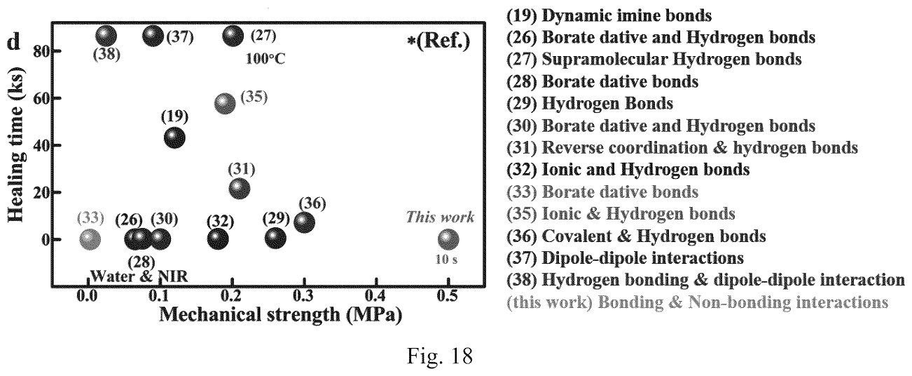

Overall, in PAA-GaF hydrogel matrix there are four types of interactions, (i) Fe³⁺—COO⁻ (ii) coordination, (iii) H-bonds, and (iv) Van der Waals interactions originating from a network of embedded electrostatic centres. The hydrogel containing Fe³⁺ has the tendency of crosslinking due to the high electron donating features of the carboxyl of PAA and GA, displaying healing via non-covalent interactions. However, the Fe³⁺—COO⁻ interaction is not true ionic interaction as electrons are not completely donated but shared between the two ions and is referred to as coordination reformation interaction as endorsed from IR spectral investigation. The occupancy of oxygen anion by Fe³⁺ facilitates hydrogen bonding at adjacent oxygen with freely available hydrogen on GA and PAA chain. This way Fe³⁺ not only contributes to ion-ion interaction and coordination bonding, but also reinforces H-bond formation in both hydrogel synthesis and self-healing. This is the reason why attempts to fabricate hydrogel from PAA and GA alone yield a hard sheet matrix with no healing characteristics. Reformation can also be obtained from non-bonding electrostatic interactions between lone pair n electrons of oxygen (see FIG. 3) with active ions (Fe³⁺, COO⁻). This combination of ion, coordination, hydrogen, and electrostatic based interactions simultaneously induce fast self-healing while retaining high mechanical strength (see FIG. 18, in which a sample hydrogel made using a preferred fabrication method (details of which will be described later) according to one embodiment, designated by “this work”, is compared with prior art hydrogels with different types of bonds).

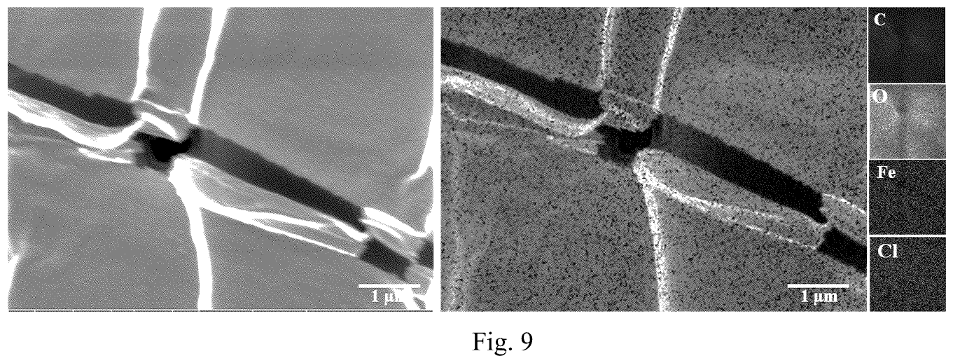

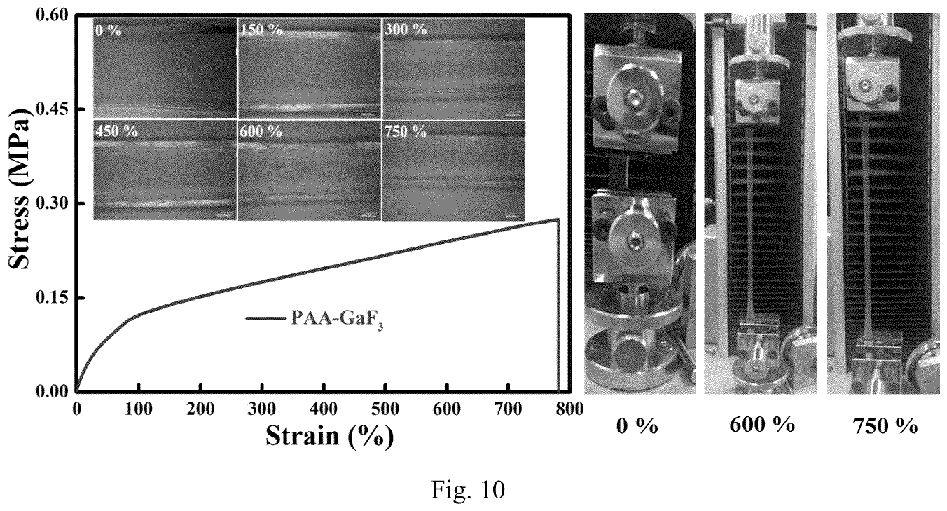

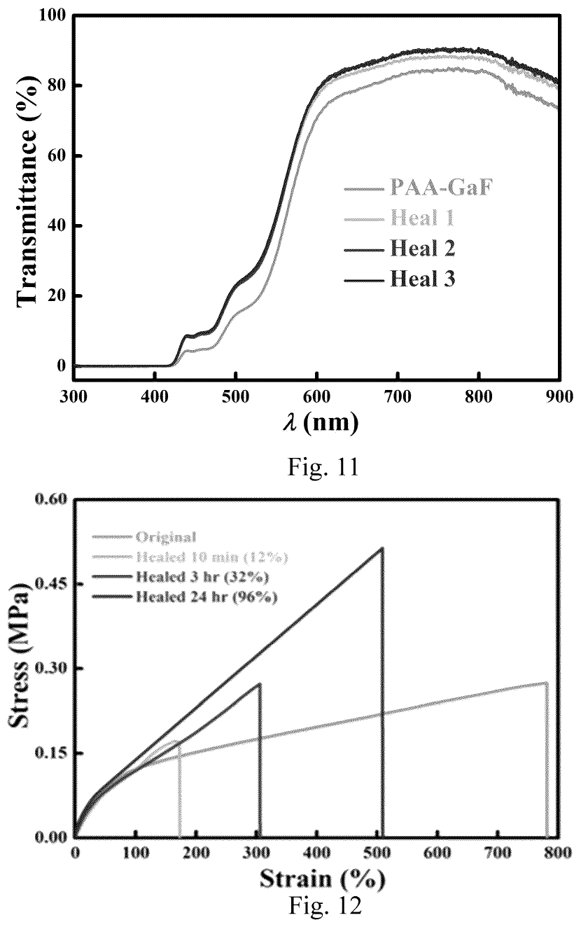

For the demonstration of autonomous self-healing, the sample PAA-GaF hydrogel was physically disconnected by 15 μm crack (wedge) or cut (scissor) and then re-joined. When the cut edges are joined, Fe³⁺ diffuses toward the fracture, inducing high density crosslinking. The healing rate is determined by the diffusion of Fe³⁺ ion towards the edge, which depends on the concentration of Fe³⁺. At high concentration, Fe³⁺ causes entanglement of PAA and agglomeration of Fe³⁺ and hence healing is slow. At low concentration, the availability of Fe³⁺ for diffusion is limited and thus reformation is dominated by free floating carboxylic and hydroxyl end groups in form of hydrogen bonding, leading to fast self-healing with low mechanical strength. In PAA-GaF, the availability of diffusion-less electrostatic and hydrogen bonding sites on GA cluster also assists Fe³⁺ diffusion via eliminating PAA entanglement and offers temporary bonding debonding diffusion-less transport dynamics. Physically the healed mark remained visible for 60-95 min (see FIG. 8), but the electrical conductivity recovered in 10s as depicted from its use in electronic circuit as switch. Energy dispersive spectroscopic elemental mapping shows that Fe, C, O and Cl elements are evenly distributed around the healing outgrowth endorsing the role of ionic, covalent and electrostatic entities in self-healing (see FIG. 9). Generally, the drawback of wet and freezing states is the utilization of all the available hydrogen bonding sites, thus hindering the dynamic ionic and covalent reformation interactions, as reported for self-healing materials in wet and freezing states. However, the hydrogen bonding and electrostatic sites of GA in the PAA-GaF are graft copolymerized on PAA backbone and thus cannot be crystalized or washed away. Therefore, the hydrogel exhibits self-healing function in wet and −30° C. freezing states (see FIG. 8) by switching the self-healing from Fe³⁺ dynamics to reform interactions. The multi-dynamic interactions also result in highly folded chains with less entanglements and inter-chain distances, allowing easier chain sliding and hence impart high stretchability of 780% (see FIG. 10). The fracture stress of healed PAA-GaF is greater than pristine hydrogel as matrix Fe³⁺ movement towards the cut interface during healing increases the amount of Fe³⁺ at the interface and hence the crosslinking density. Due to the active Fe³⁺ movement towards the cut interface, a slight enhancement in transparency of the film is observed, as shown in FIG. 11, reducing the crosslinking density to 96% healing efficiency (see FIG. 12).

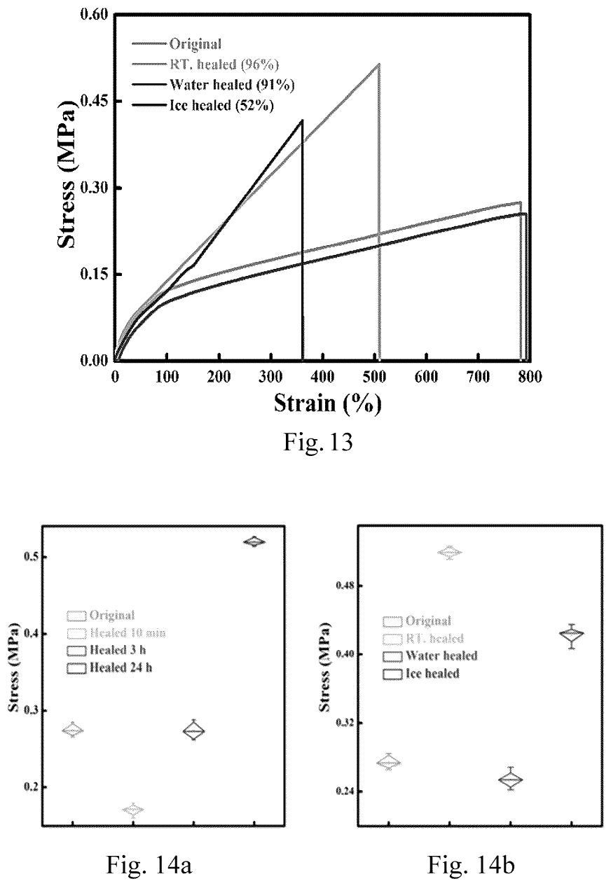

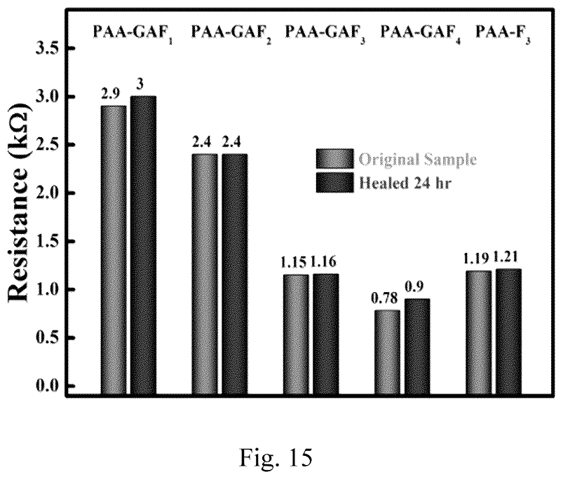

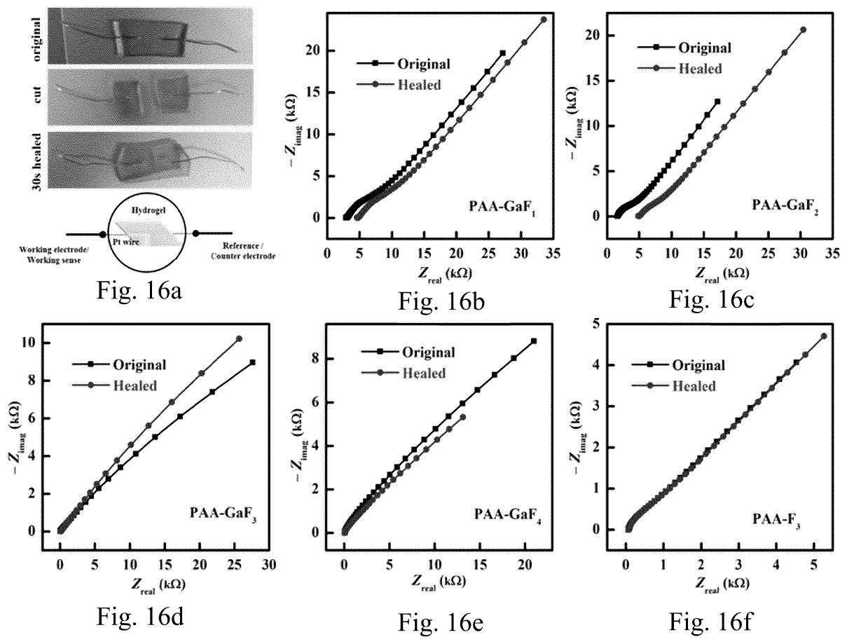

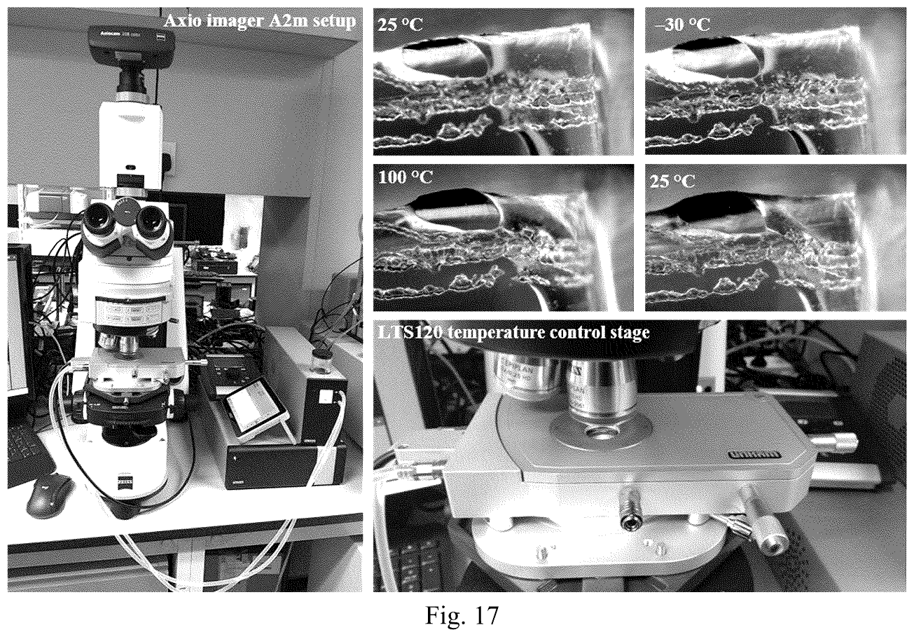

However, for water healed PAA-GaF the strain is manifested with lower fracture stress compared to pristine hydrogel, which is attributed to restriction of Fe³⁺ dynamics in the aqueous medium and hydrogen bonding between water and electrostatic centers of PAA-GaF. The healing efficiency in wet and freezing states was 91% and 52%, respectively, after healing for 20 min (see FIG. 13). The error bars in the mechanical measurements show negligible deviation, endorsing the stability and reproducibility of the materials (see FIGS. 14a-14b). Such a rapid healing efficiency without external stimuli in ambient and harsh environment is very rare, especially for dry polymeric materials due to their slow chain mobility and chemical bonds dynamics in the absence of solvent. The electrical resistivity (see FIG. 15) of all samples before and after self-healing remains the same (PAA-GaF₃, Δ˜0.8%), and in some cases increased over original samples (PAA-GaF₃, Δ˜15%), due to decrease of the Fe³⁺ crosslinking density and aggregation. Electrochemical impedance spectroscopy (EIS) is a resistance measurement technique based on Ohm's law that gives results in both domains, time and frequency. It enables the evaluation of interfaces using multi-frequency excitation, which allows simultaneous measurement of polarization, ionization, and diffusion processes. Since EIS uses small AC perturbation for evaluation, it does not superimpose the DC output and is a non-destructive technique, making it suitable for real-time investigation. Based on these characteristics, EIS was used to monitor the recovery of the electrical properties of the pristine hydrogel film after 30s healing of a cut mark, where the impedance profile was recorded as nyquist plot (see FIGS. 16a-16f). In the nyquist plot, the high frequency left part (usually semicircle) represents the charge transport and the low frequency right part corresponds to diffusion induced mass transfer. It can be observed that the charge transfer resistance increased after healing for PAA-GaF₁ and PAA-GaF₂ hydrogels and the low frequency equivalent series resistance was slightly enhanced for PAA-GaF₃ and PAA-GaF₄. However, the impedance spectra remained unchanged for PAA-F3 hydrogel, suggesting that the slight change in resistance after healing is due to the slow dynamics of Fe³⁺ ion in the film, and in the GA crosslinked hydrogel, the availability of free Fe³⁺ ions is less leading to high transport resistance. These results are consistent with the sheet resistance measurements of the hydrogel film. The hydrogel matrix is preserved at extreme temperatures of −30° C. and 100° C., as depicted from the cycling cooling and heating profile of the hydrogel film under optical microscope observation (see FIG. 17). This behavior is advantageous over conventional hydrogels where water gets fully crystalized upon freezing. In summary, the strong bonding interactions of PAA-GaF hydrogel impart high mechanical endurance while the weak electrostatic interactions result in fast autonomous self-healing. This led to a mechanically stable, self-healable hydrogel network with no water puncturing issue that can be used in prosthetics powering electronics owing to the conductive framework with high delocalization centers offering efficient charge induction.

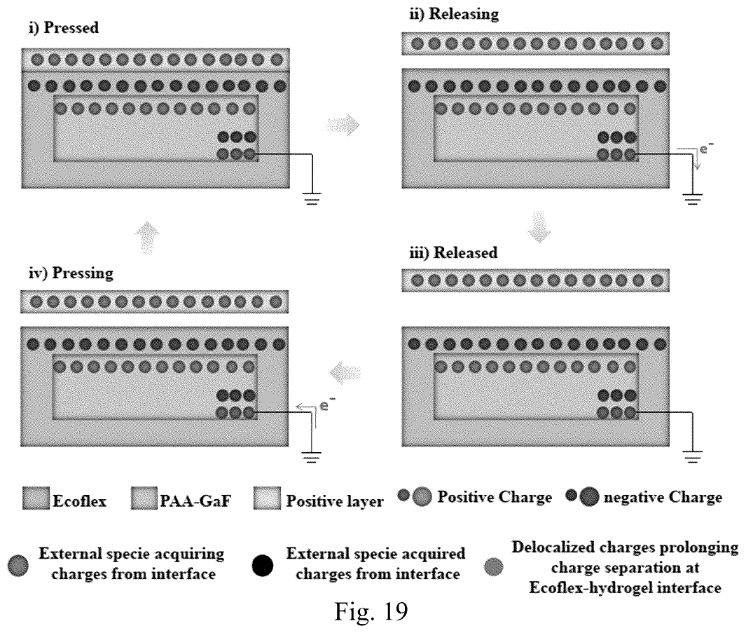

When the PAA-GaF hydrogel sealed in ecoflex elastomer is connected to the ground by metallic lead through external load, the hydrogel works as single-electrode device (SHE-TENG) as shown in FIG. 19. Once a tribopositive film contacts the elastomer film, electrification occurs, which generates the same amount of charges with opposite polarities at the surface of the elastomer and tribopositive film. Since the opposite charges coincide at the same plane, they end up with practically no electrical potential difference between the surfaces. When the two surfaces start moving away, the static charges accumulated on the surface of ecoflex induce movement of the ions in PAA-GaF to balance the static charges, and thus form a layer of excessive positive ions at the ecoflex/hydrogel interface. Meanwhile, an electrical double layer is formed at the hydrogel/metal interface and gets polarized, resulting in the formation of the same amount of excessive negative ions on hydrogel and positive charges on metals at their interface. To attain electrical double layer, electrons flow from metal wires to ground via external circuit (negative current signal) until all the static charges from ecoflex are screened. This double layer at the metal/hydrogel interface usually has a thickness in nanometer range with very high capacitance ˜0.1 Fm⁻² and low voltage across the double layer ˜10⁻² V. Therefore, the interface does not undergo any electrochemical reaction as the voltage is below 1 V. As long the positive layer is far away from ecoflex, all the charges and ions are in electrostatic equilibrium. When the tribopositive layer re-approaches the ecoflex film, the electrostatic equilibrium breaks down and the whole process is reversed, and an electron flux will transfer in opposite direction from ground to metal/hydrogel interface via an external load producing positive current signals. By approaching and withdrawing the positive layer, alternative current signals will be generated.

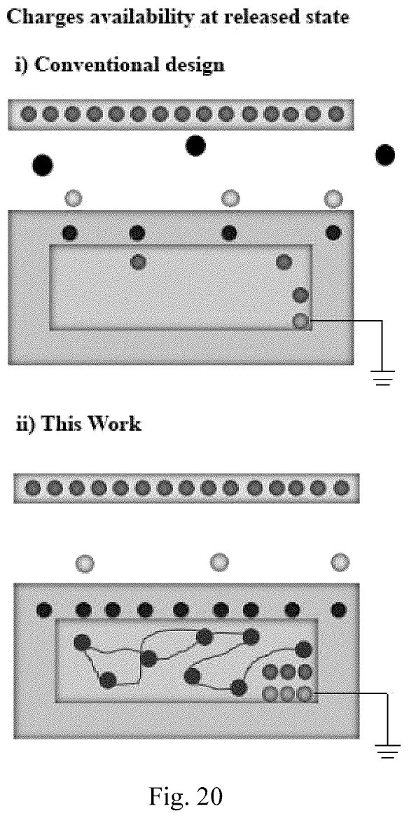

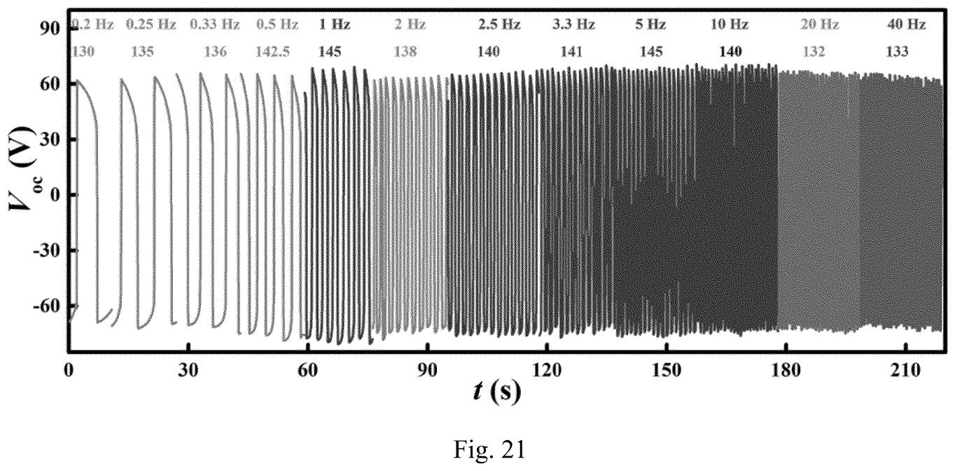

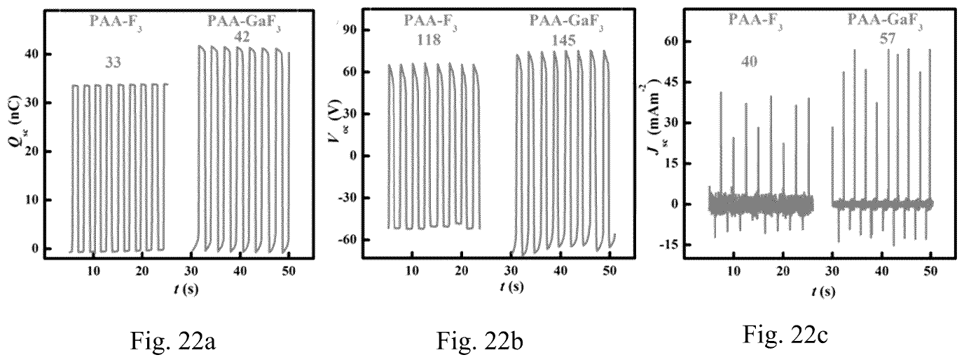

The open circuit voltage (Voc) and short circuit charge quantity (Qsc) are zero when the positive layer is in contact with the ecoflex layer. When the positive layer is withdrawing the Voc and Qsc become, Voc=−σA/2Co and Qsc=−σA/2, respectively. Where o is the electrostatic charge density generated on the surface of ecoflex, Co is the overall capacitance of SHE-TENG, and A is the contact area between ecoflex and the moving positive layer. The SHE-TENG is an electrostatic system and has inherent capacitive behavior that integrates several capacitors. The capacitive layers develop between (i) positive layer vs. ecoflex electrification layer, (ii) ecoflex electrification layer vs. PAA-GaF, and (iii) electrical double layer capacitance between PAA-GaF vs. silver lead between two surface nodes. The highest contribution comes from PAA-GaF vs. silver capacitive layer, which depends on the number of electrons and ions in the double layer. When the positive layer is away, the negative charges on ecoflex are normally screened by both the hydrogel layer and charged particles available in the atmosphere (see FIG. 20), which reduce the number and duration of induced charges in the hydrogel network. This leads to performance degradation at a lower contact-separation frequency. In the present case, due to the primary and secondary dynamic bonding, densely distributed electrostatic and hydrogen bonding centers in PAA-GaF network, more charges are screened from the ecoflex layer with further high delocalization density of the screen charge in the hydrogel matrix, leading to consistent output at wide range of contact-separation frequencies from 0.2 to 40 Hz (see FIG. 21). Moreover, the high electron delocalization density at GA electrostatic and hydrogen bonding active sites in the hydrogel matrix, slows down the charge leakage, which poses a critical issue in conductive induction layers, and hence hinders performance degradation (see FIGS. 22a-22c).

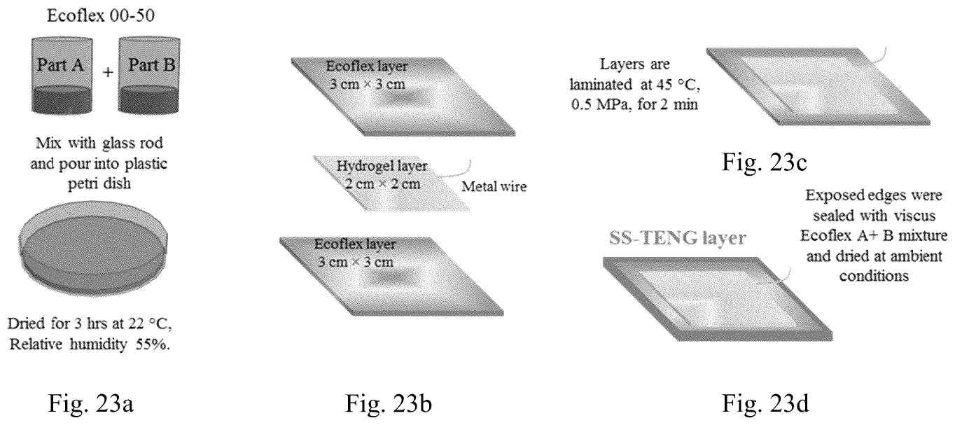

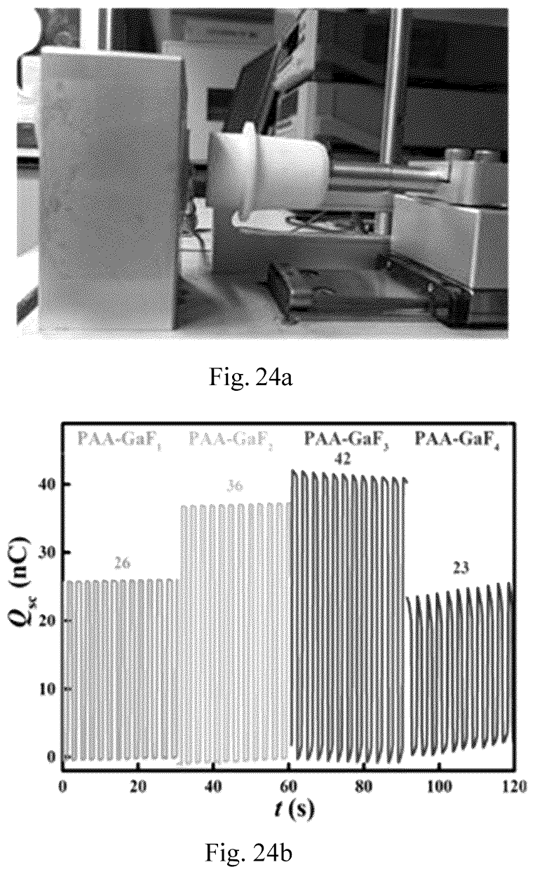

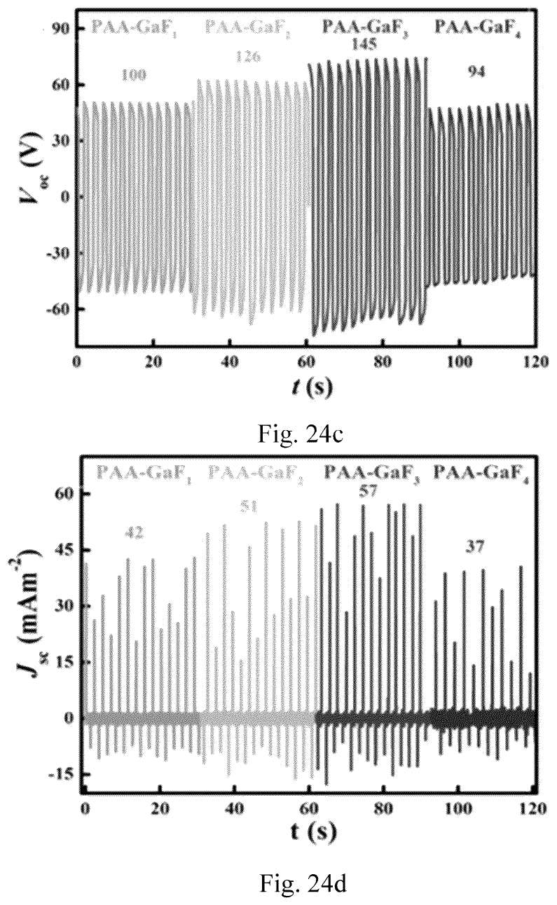

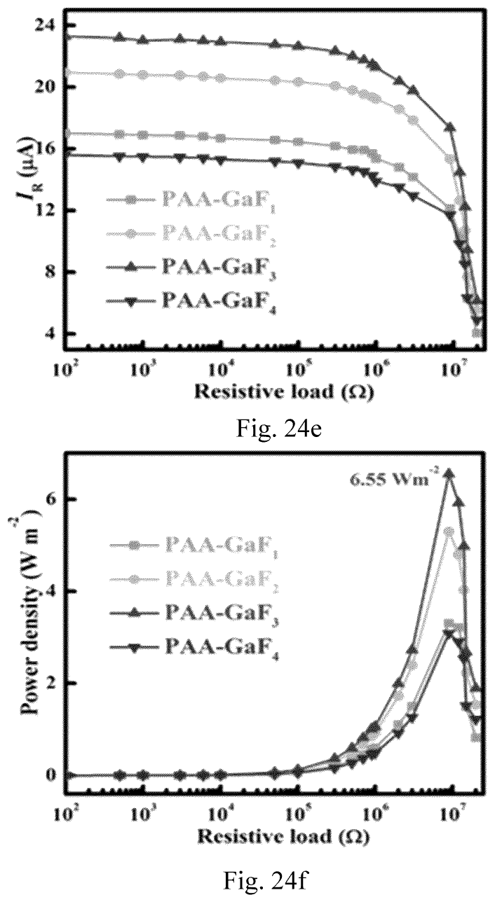

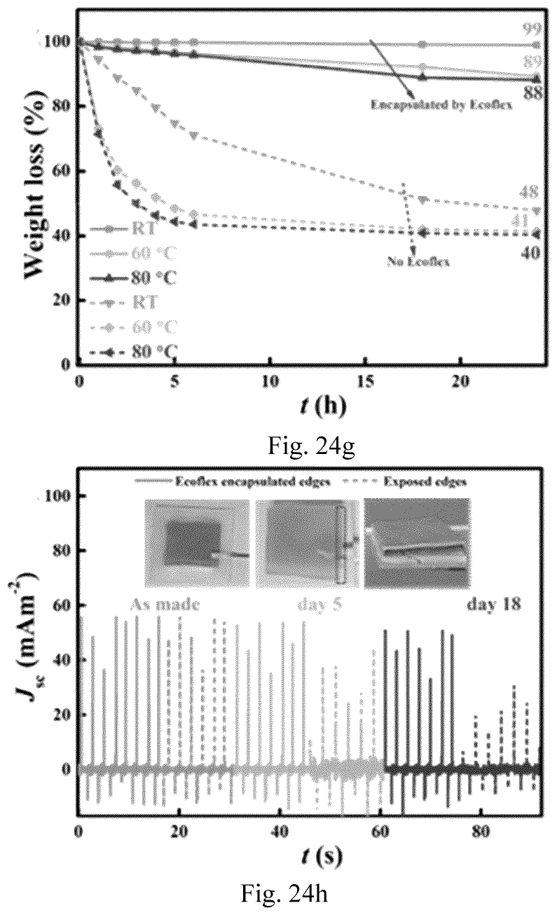

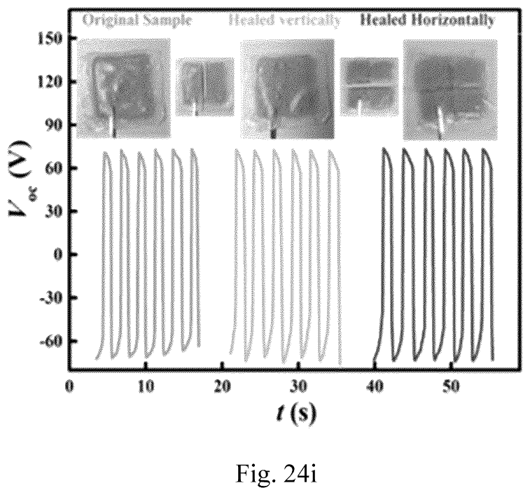

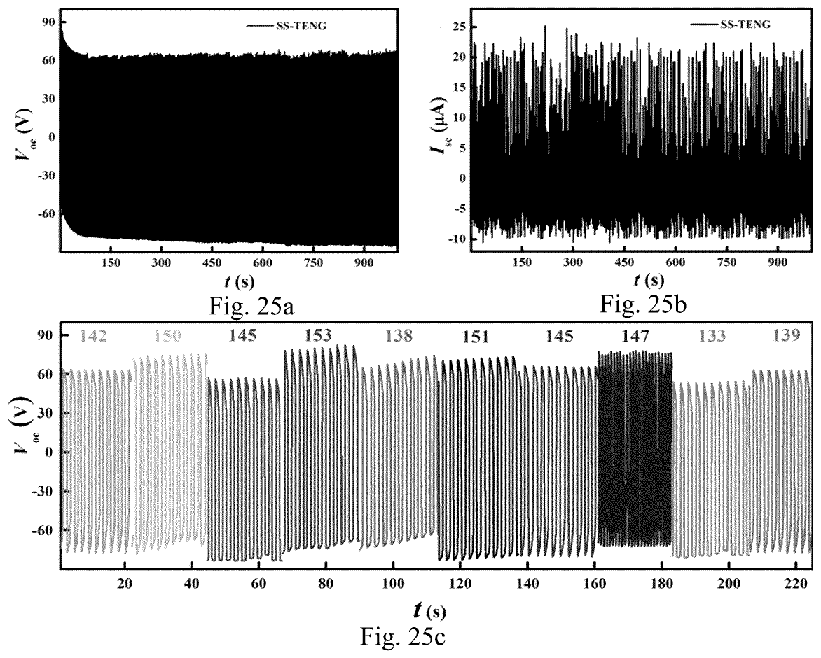

In a SHE-TENG device according to an embodiment of the invention, the device has a PAA-GaF induction layer enclosed in two layers of ecoflex through vacuum lamination to avoid air gaps, followed by edges sealing with VHB tape and fresh ecoflex gel (see FIGS. 23a-23d). After drying out the ecoflex edges, the single electrode tribonegative layer was connected to ground to study the output performance against approaching polyethylene foam head of linear motor as the tribopositive layer (see FIG. 24a). The key performance factor of SHE-TENG is dependent on the charge induction by the conductive matrix enclosed in the ecoflex layer. This way, the charges are easily screened from the ecoflex layer, but due to the high conductivity of the induction layer, a portion of charges contribute towards the output, while some flow as leakage charges. In PAA-GaF, the excess charges, instead of leaking, delocalize on electrostatic active sites of GA graft. This delocalization is switched to dynamic Fe³⁺ bond; therefore, the output performance is dependent on the concentration of ferric chloride in the GA and PAA matrix. It can be observed that the amount of charge transfer increases up to 3 wt % Fe³⁺ crosslinking, complement the delocalization over electrostatic sites, but further increase leads to performance degradation as the Fe³⁺ conductivity becomes dominant over the activity of electrostatic sites. The output of a sample SHE-TENG (2×2 cm² area) as fabricated was measured at contact separation frequency of 1 Hz, speed 1 m s⁻¹ with acceleration/deceleration rate of 1 m s 2. The SHE-TENG with PAA-GaF₃ shows high charges transfer of 42 nC, generating a Voc of 145 V with Jsc of 57 mAm⁻² (see FIGS. 24b-d). The power density of SHE-TENG under a series of external load resistance ranging from 100Ω to 20 MΩ was evaluated using the equation, P=I²R/A, where I is the output current per cycle in the external load, R is the load resistance, and A is the contact area. The current output on the external load gradually decreases when the resistance is lower than 1 M Ω; and with further increase, the current output decreases rapidly due to significant energy consumption by the resistor (see FIG. 24e). The corresponding power density shows significant increase with load resistance, and a peak power density of 6.55 W m⁻² was achieved on 9 MΩ resistors (see FIG. 24f). The power density exceeds reported hydrogel-based devices, owing to the strength of interfacial bonding between ecoflex and hydrogel and delocalization of charges in induction layer. Furthermore, the durability of SHE-TENG and hydrogel layer was studied after dehydration at room temperature (22° C.), 60° C., and 80° C. and exposure to relative humidity RH of 60% for 24 h. It was observed that the hydrogel layer lost a maximum of 60% of its water ecoflex sealed hydrogel layer retains 99%, 89%, and 88% of its initial weight after dehydrating at room temperature, 60° C., and 80° C., respectively (see FIG. 24g). For the performance durability, two devices (exposed edges and fully sealed) were studied at various intervals after storage in desiccator with a hygrometer for 18 days (22° C., RH 10%). The device with exposed edges quickly degraded and converted into a solid mass, resulting in performance degradation and destabilization. On the other hand, the dried device maintained strong contact with the ecoflex layer, denoting that the strength of interfacial bonding is independent on the hydrogel water content. For the sealed device, the dehydration rate was prolonged due to less water permeability of the ecoflex layer (see FIG. 24h). For mechanical durability, the device was subjected to continuous contact separation cycles for 1000 s (at 1 Hz), where no noticeable output change was observed indicating robustness of the device (see FIGS. 25a-25b). Moreover, ten different devices with the same dimensions (2 cm×2 cm) were fabricated, and their output signals show a slight deviation (±6 V) across the devices (see FIG. 25c), showing reproducibility of the device design. For self-healability, the device performance was tested every 3 min, after cutting the device in horizontal and vertical lines (see FIG. 24i), demonstrating the fastest recovery of electrical properties of hydrogel. In another test, 60 devices were tested in ambient conditions, and all had almost same output voltage with 1-3 V deviation. The output remains intact after 1000 s contact separation loops. The SH-TENG was cut two times and the output before and after self-healing from cut remains the same.

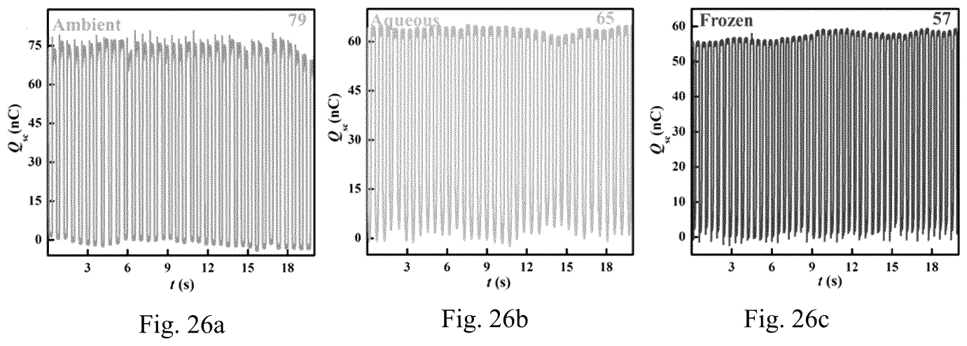

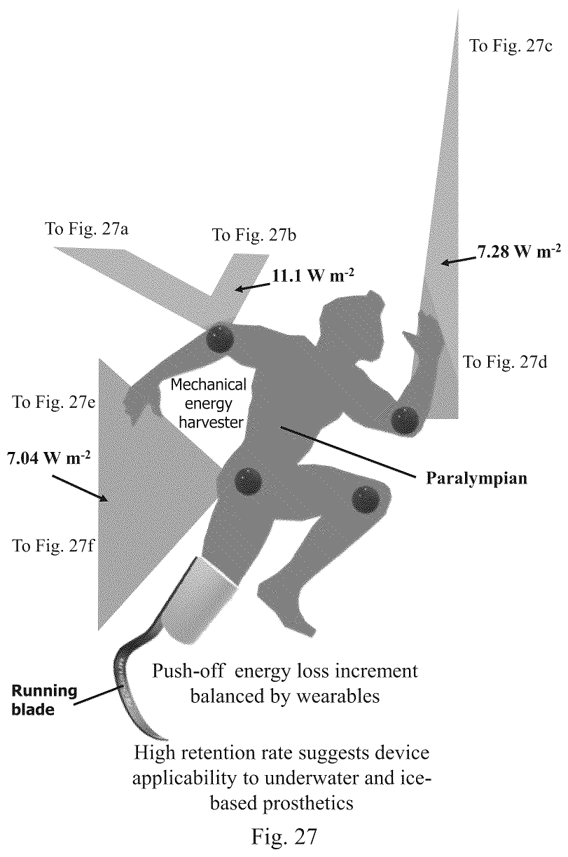

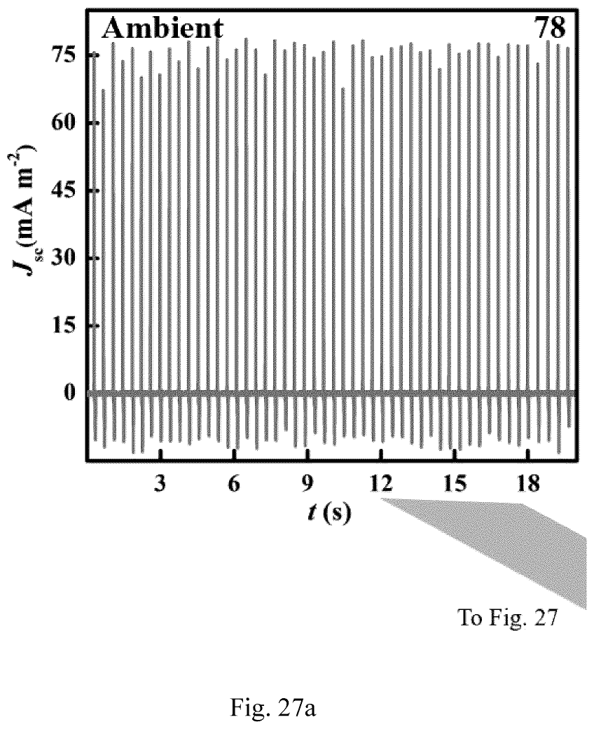

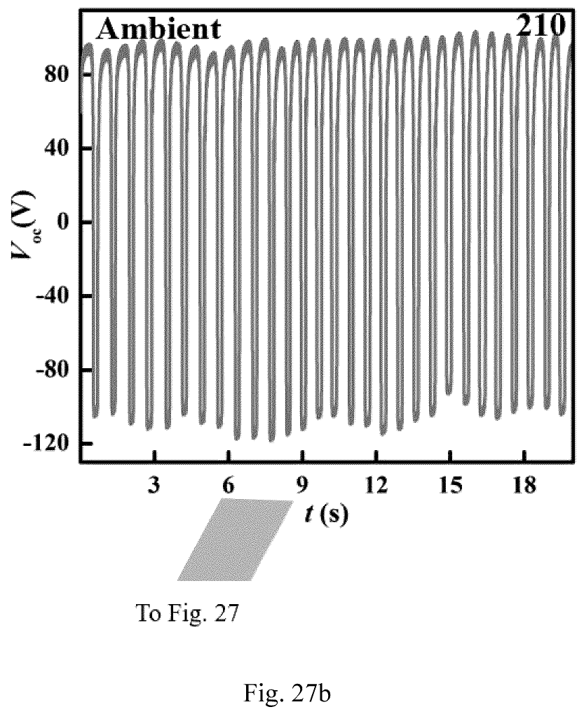

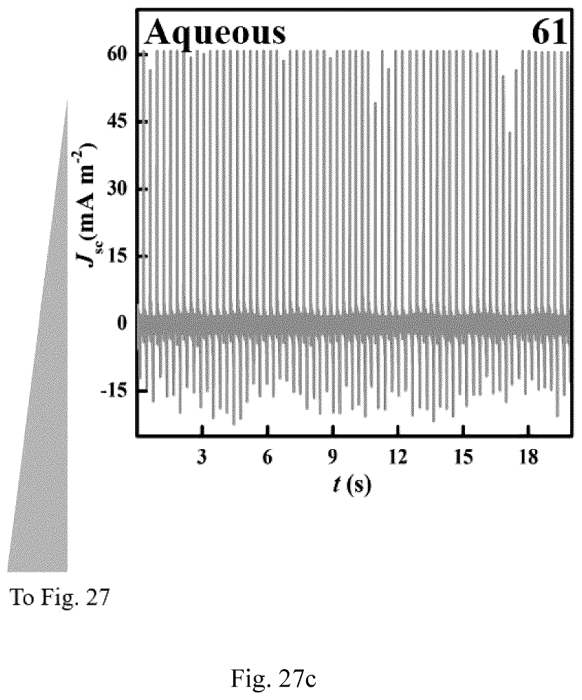

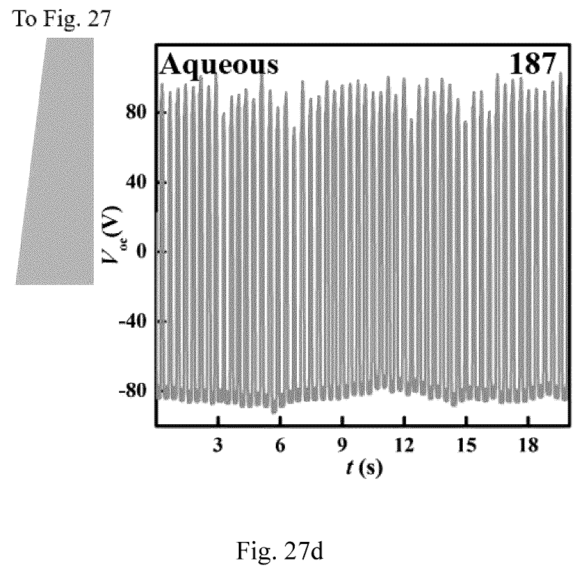

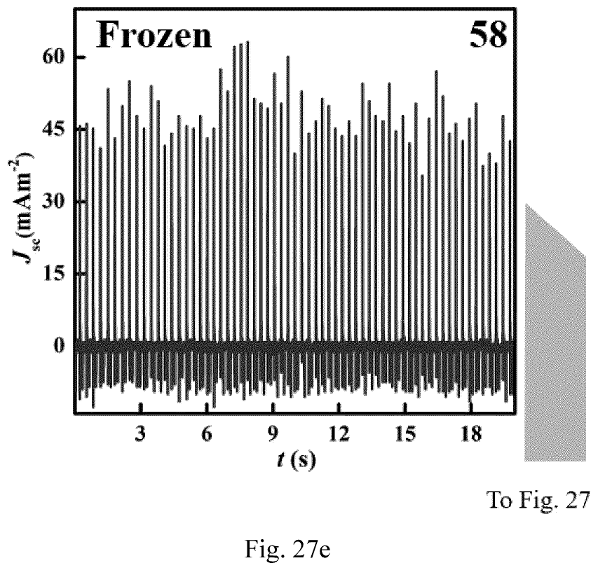

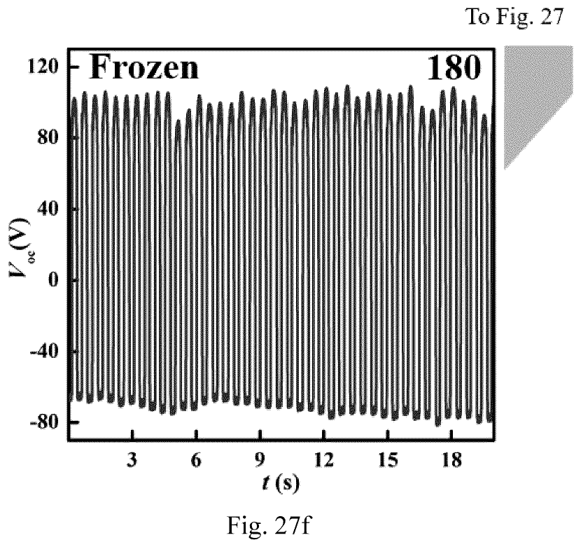

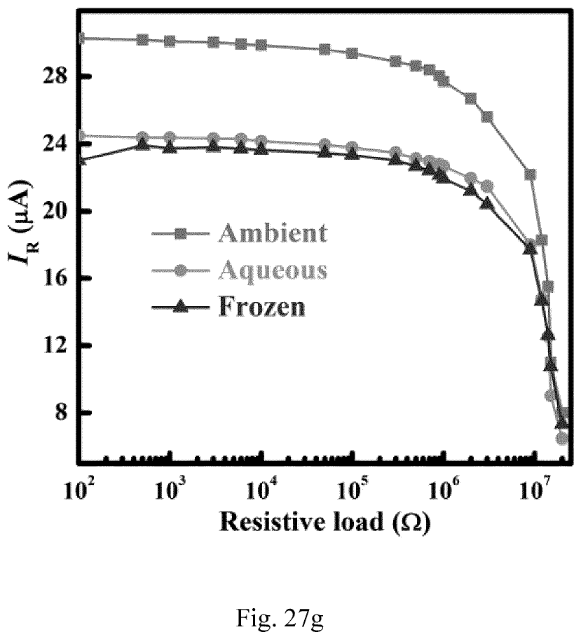

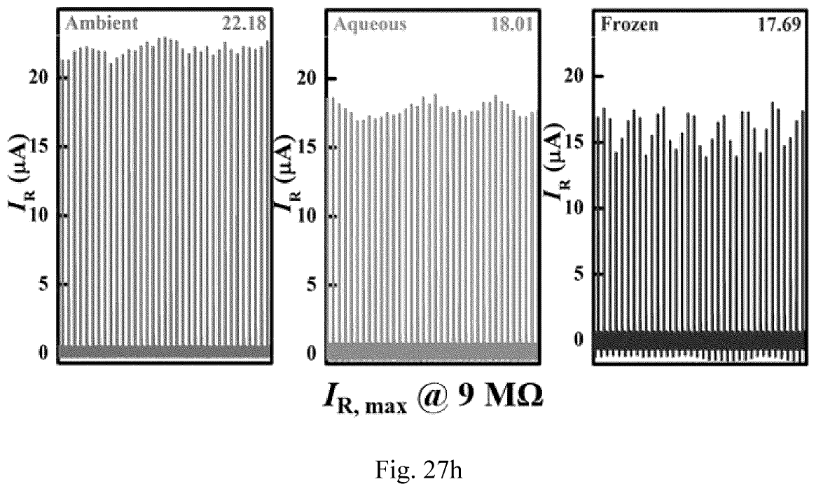

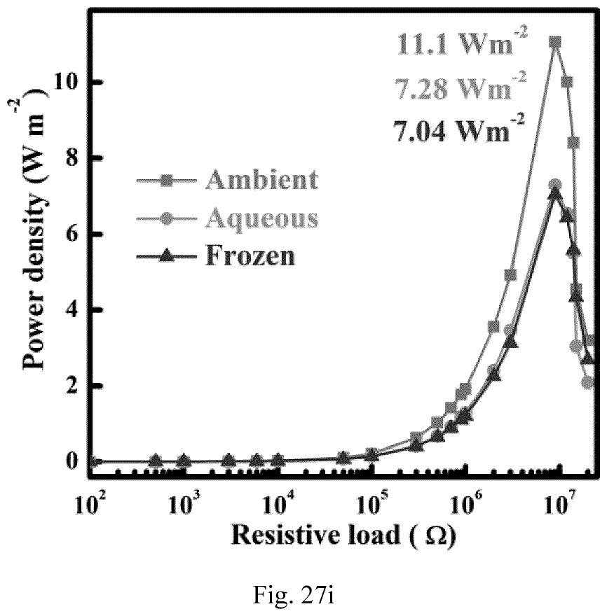

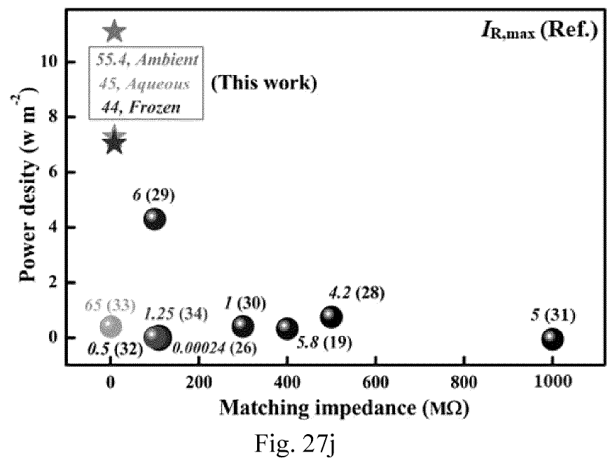

Generally, single electrode devices are used for harvesting energy from human motion, where skin is used either as static or dynamic tribopositive layer. Human skin is three-layered stratified tissue, where the layers from top to bottom are epidermis, dermis, and hypodermis. The outermost epidermis layer is called stratum corneum (SC) with thickness of 10-20 μm. SC comprises 15 tightly stacked layers of flattened dead cells enriched with keratin embedded in intercellular matrix, which is composed of ceramics, long-chain free fatty acids and cholesterol. In addition to chemical composition, SC has low water content acting as barrier against exogenous penetration, thereby acts as biological tribopositive layer. The output performance of the sample SHE-TENG against skin shows significant enhancement compared with PE foam with Qsc of 79 nC (see FIGS. 26a-26c), generating Voc of 210 V and Jsc of 78 mA m⁻² (see FIG. 27a and FIG. 27b).

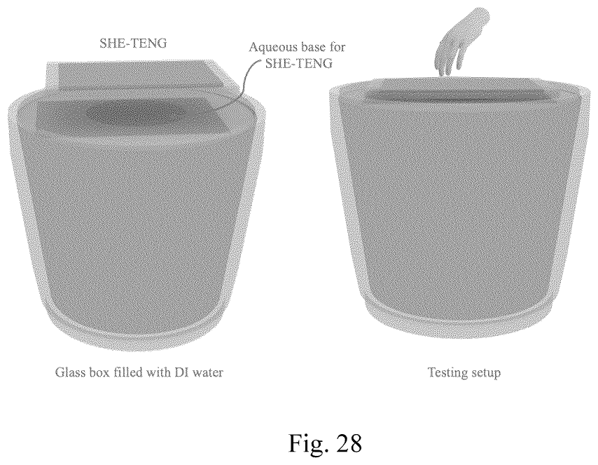

Furthermore, owing to the retention of the self-healing characteristics of the hydrogel, the performance of the sample SHE-TENG was retested in freezing state. For the aqueous state, SHE-TENG was submerged in DI water for 24 h and tested in aqueous state chamber. In particular, in a triboelectric nanogenerator, when the positive layer is withdrawing from contact with ecoflex, Voc becomes Voc=−σA 200, where o is the electrostatic charge density generated on the surface of ecoflex, Co is the overall capacitance of SHE-TENG, and A is the contact area between ecoflex and the moving positive layer. Since an electrostatic charge is present on ecoflex surface, its exposure to charged hydroxyl-based aerosol particles greatly affects the number of charges induced by the induction layer and hence the electrical output performance. In this case due to higher charge screening tendency of the induction layer compared to the surrounding (see FIG. 20), the number of induced charges and their retention are independent of the active species in the surroundings of the ecoflex layer. Thus, SHE-TENG was stored in DI water for 24 h and tested in a controlled aqueous glass box, where the lower end of the ecoflex is exposed to the water channels through continuous pores, and the device was tapped from the top side to measure the aqueous state output (see FIG. 28), showing 87% performance retention (see FIGS. 27a-27j), which endorses the high-density charge induction postulate.

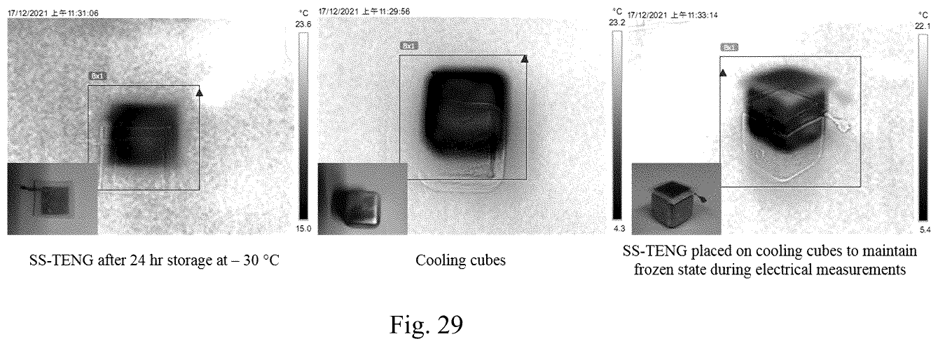

The sample SHE-TENG in aqueous state generates 65 nC, Voc of 187 V and Jsc of 61 mA m⁻² (see FIG. 27c and FIG. 27d). For freezing state, the device was kept at −30° C. for 24 h and the output was retested while keeping the device on cooling cubes as indicated in FIG. 29. In particular, for evaluation of the freezing-state performance durability, the device was stored at −30° C. for 24 h. However, the device maintained a temperature around 0° C. due to the thermal insulating properties of the ecoflex encapsulant (see FIG. 29). Thus, hydrogel crystallization was prevented to a great extent. The freezing-state testing was carried out on a stainless steel cooling cubes that were also stored at −30° C. To ensure accuracy of the output results, several devices and cooling cubes were stored at −30° C., and after every 2 minutes a new set of devices and cooling cubes were used. For cycling stability testing, a cooling cube base was submerged in an ice bath set at −30° C. to maintain the freezing-state environment.

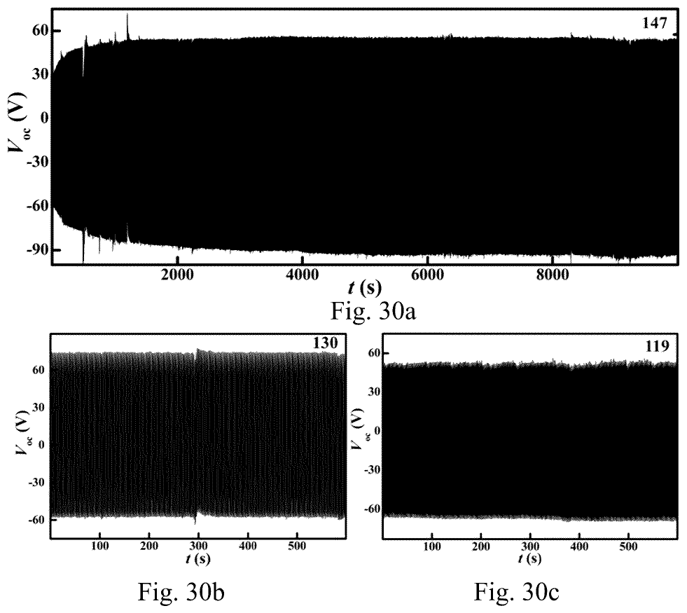

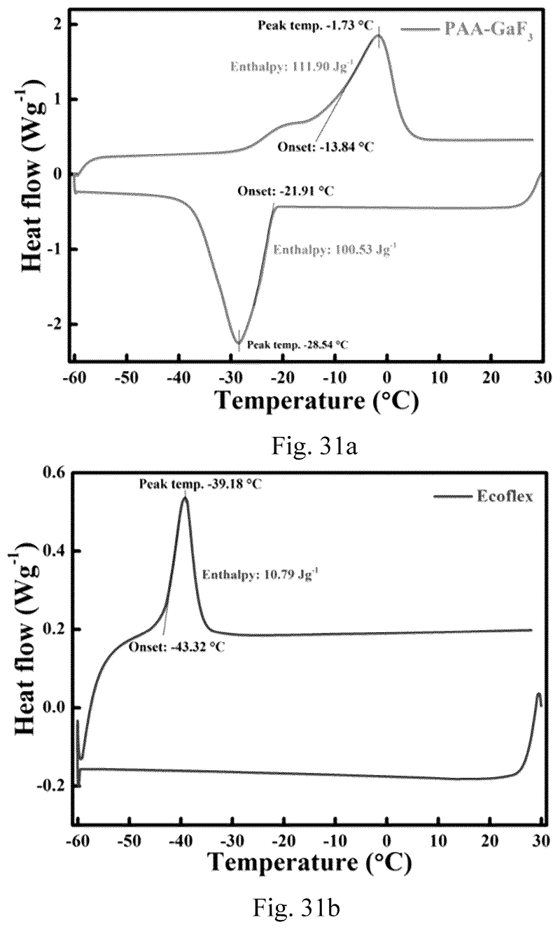

The sample SHE-TENG device generates Qsc of 57 nC, Voc of 180 V and Jsc of 58 mA m⁻², displaying 80% performance retention compared to ambient state output (see FIG. 27e and FIG. 27f). Further, SHE-TENG shows excellent cycling stability after healing in ambient, aqueous, and freezing states and their stability in corresponding environment (See FIGS. 30a-30c). In particular, the PAA-GaF induction layer was cut into four pieces and allowed to self-heal in various environmental conditions of ambient, aqueous, and −30° C. freezing states. Cycling stability of SHE-TENG was studied after healing to assess the performance durability over successive contact-separation loops (see FIGS. 30a-30c). The output voltage against PE counterpart of the self-healed device in ambient environment remains stable after 10,000 contact-separation cycling loops, displaying excellent healing reformation of the electrode. Further, the aqueous and freezing self-healed electrodes maintain constant output voltage in aqueous and freezing conditions. The SHE-TENG in pristine form shows Voc of 151 V against PE counterpart, which decreases to 147 V (ambient), 130 V (aqueous), and 119 (freezing) after self-healing in the corresponding states. This indicates 97.4%, 86%, and 79% performance retention in different environments, which is consistent with the other results.

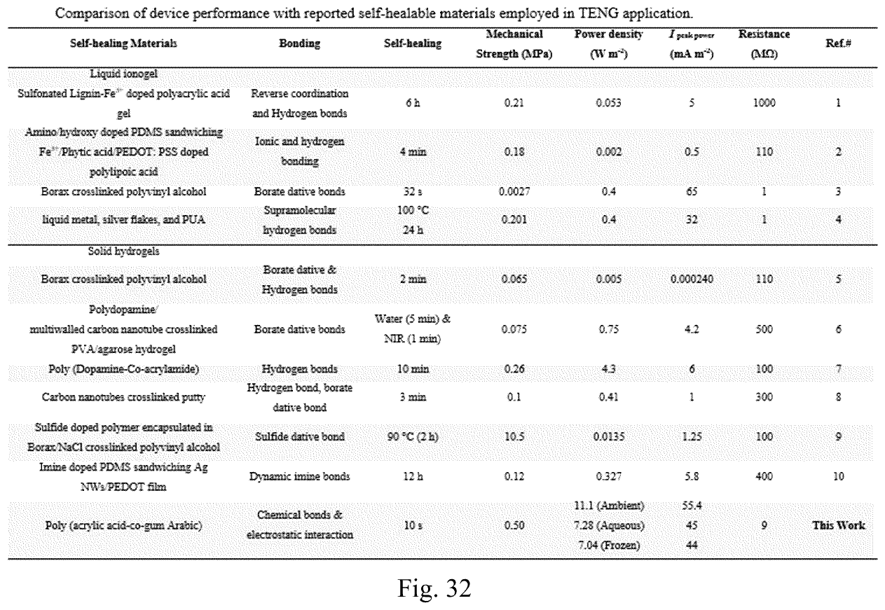

For insight of the performance retention at −30° C., the hydrogel freezing/crystallization temperature is investigated, the rate of heat flow and thermal transitions of the hydrogel and ecoflex elastomer was evaluated using differential scanning calorimetry as shown in FIGS. 31a-31b. The DSC thermogram of hydrogel exhibits a wide exothermic peak at peak temperature of −28.54° C. and an endothermic peak at peak temperature of −1.73° C., whereas ecoflex displayed only an endothermic peak at peak temperature of −39.18° C. This indicates that the freezing or crystallization of hydrogel starts above −21.91° C., and the ecoflex does not undergo freezing till −60° C. and contributes to the performance retention by acting as anti-freezing encapsulation of the hydrogel induction layer at −30° C. (see FIG. 29). The hydrogel retains its self-healing property in freezing state due to switching of self-healing from Fe³⁺ interaction to ice-like hydrogen bonding, retaining high healing efficiency (see FIG. 13). To investigate the capability of SHE-TENG as a power source for wearable electronics, external resistive loads were connected in the circuit to measure the device output. With increasing load resistance from 100Ω to 20 MSΩ, the output current (IR) gradually decreases, with abrupt decrease near matching resistance (see FIG. 27g). The maximum instantaneous peak power density reaches as high as 11.1 W/m² at load resistance of 9 MΩ (see FIG. 27i) corresponding to peak current density (Imax) of 22.18 mA m⁻² (see FIG. 27h), which overperforms all reported liquid, semisolid, and solid based self-healable TENGs as shown in FIG. 27j. Further details of the comparison are provided in the table in FIG. 32. Additionally, SHE-TENG retains high power density of 7.28 W m⁻² in aqueous and 7.04 W m⁻² in freezing state, corresponding to I_{max, aqueous} of 18.01 mA m⁻² and I_{max, freezing} of 17.69 mA m⁻², demonstrating that the potential of SHE-TENG not limited to ambient state electronics or prosthetics but can also be extended to underwater, freezing environment power back-up, and cryogenics.

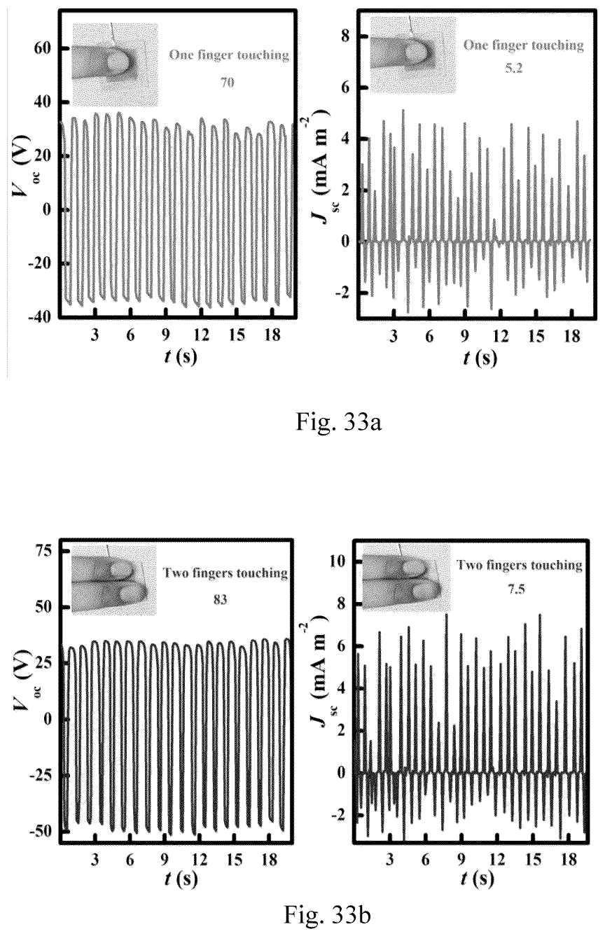

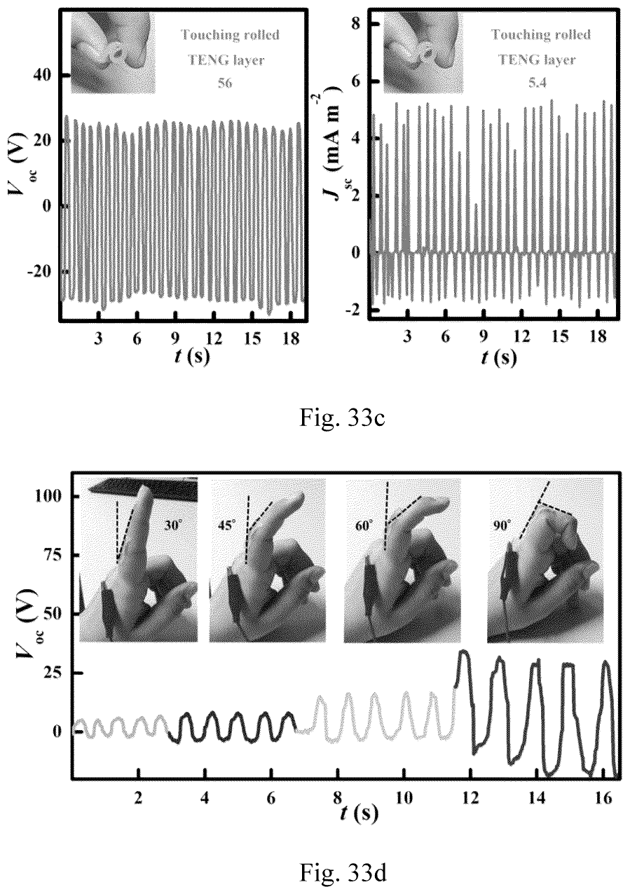

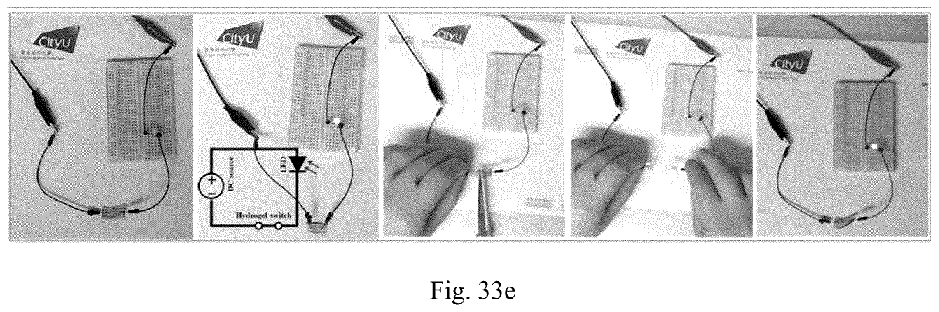

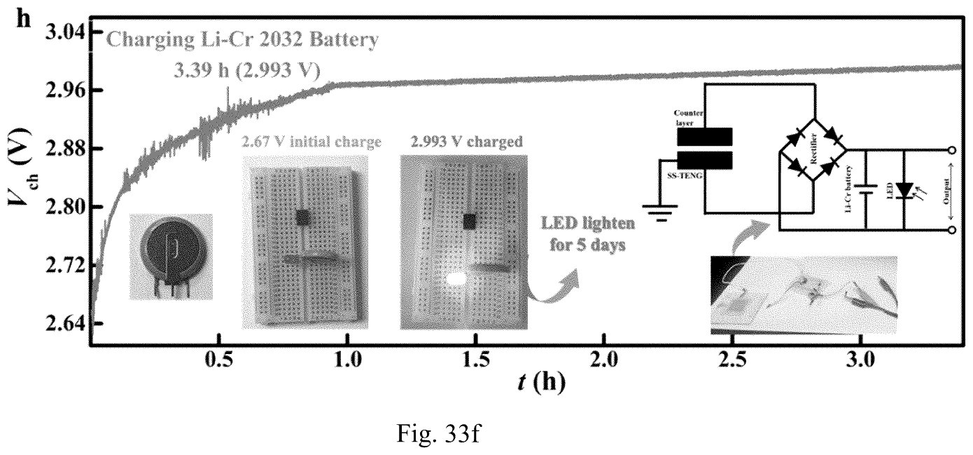

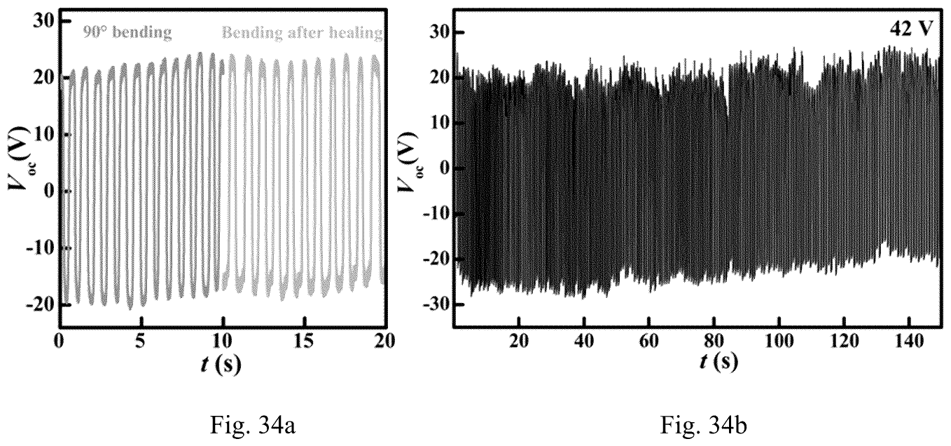

Further, for demonstrating the capability of SHE-TENG as human motion sensor, the device output observed upon slight touch of fingers is between 5 and 7.5 mA m⁻² as shown in FIGS. 33a-33c. Also, a thin layered device was mounted to finger and the output voltage variability with bending angle was monitored (30°: 6 V, 45°: 12.2 V, 60°: 20 V, 90°: 46 V) as depicted in FIG. 33d. The performance remained intact for the self-healed induction layer of the device (see FIG. 34a) for prolonged contact separation cycling loops (see FIG. 34b). These results not only demonstrate the deformability of the device, but also the potential application as prosthetic sensor for body movement indication. For instance, the body motion or even bending angle of paralyzed patient can be detected through a software signals manipulation interface, where the exact recovery duration and drug's effectiveness can be estimated. Also, SHE-TENG can be used as emergency signals activator in intense care situations. Briefly, when a user gently touches an object attached on the device, the resultant output will be interpreted by a software as digital numbers or sound signals, which is much more convenient than pushing the emergency button and is thus more suitable for special cases. Further, the SHE-TENG was investigated as power source by changing the AC output from hand taping the device to DC via rectification and connected to high power LEDs at the other end of the bridge rectifier. When a 9 cm² device was tapped, ˜500 LEDs of 0.06 W each were illuminated. However, to further endorse the high-power density and low matching impedance feature, the device was used to light up 104 LEDs of 0.5 W each. The hydrogel is used as a switch in the electrical circuit by connecting one end to DC power source and the other to an LED bulb indicator (see FIG. 34c). The hydrogel is cut by scissors and re-joined; a quick recovery of the electrical conduction is confirmed by lightening of the LED after re-joining. Further, the SHE-TENG is connected to lithium-ion battery (Li—Cr 2032) to check the battery charging performance, the circuit design along with the setup is shown in the inset of FIG. 34f. Before charging, the 1.8 V red LED connected to the battery did not illuminate, indicating the discharged status of battery. After 3.39 h of continuous tapping, which is equivalent to conventional power source charging time, the battery is charged. After charging, the battery continuously lightens the LED for 5 days, demonstrating the potential of SHE-TENG for powering electronics.

A preferred fabrication method according to one embodiment, the resultant of hydrogel designated by “this work” herein, starts with acrylic acid (AA-4 mL) dissolved in deionized water (10 mL) followed by addition of gum arabic (GA-12 wt % w.r.t. AA) and stirred till clear solution formation to indicate complete dissolution of GA. The mixture was charged with cross-linker ferric chloride hexahydrate 0.12 g (3 wt % with respect to AA) and stirred for 5 min, followed by addition of 0.1 g ammonium persulfate to generate free radicals. The homogeneous mixture was transferred to plastic a petri dish, covered covered with a lid, and placed in oven for 2.5 h at 40° C.

A silicon rubber (SR, ecoflex 00-50) with base and cure weight of 1:1 was mixed and dried at room temperature. The MEH was fabricated by sandwiching a 20 mm hydrogel layer between two layers of SR. A double sided VHB tape was mounted on the lower SR layer and the hydrogel was mounted on it followed by sandwiching with another SR layer without VHB tape. The VHB sealed ecoflex coating was then treated with fresh uncured SR gel around the device edges to fully enclose the device. The use of VHB on the lower layer is to prevent the exposure of hydrogel to uncured SR gel to prevent current leakage to undried trapped gel. The dimensions of the device are 30×30×1 mm³ with 20 mm enclosed hydrogel layer as the electrically active area. A conductive Al wire was placed underneath the hydrogel for electrical connection. The thickness of the device was measured using screw gauge.

To characterize the performance of the hydrogel, field-emission scanning electron microscopy (FESEM, Quanta 450, JEOL 7100 F) equipped with EDX was used at an accelerating voltage of 10 kV for surface elemental composition of healed area. The absorbance and optical transparency of hydrogel film were recorded using UV-vis spectrophotometer (Shimadzu 2600) equipped with a 60 mm integrating sphere. The chemical composition was investigated on IR Affinity-SI (Shimadzu, Japan) spectrophotometer equipped with an attenuated total reflectance (ATR) sampling mode. All spectra were recorded in the range of 400-4000 cm⁻¹ at a resolution of 4 cm⁻¹ for 100 scans. Hydrogel was cut into rectangular dimensions of 20 mm×40 mm×2 mm for the tensile compression test, performed on TH-8203S Model (Top Hung Machine Equipment Corporation, China) testing system, with stain rate of 50 mm·min⁻¹, at room temperature. The mechanical healing efficiency, n, was defined as η=Tₕ/T₀×x 100%, where Tₕ and Tᵥ represent toughness values of the healed and original samples. Toughness was calculated from integration of the area under stress-strain curves. Keyence Digital Microscope (VHX-1000, Japan) was used for examination of self-healing process at room temperature. The resistance of the film was measured through Van der Pauw method using Keithley 2400 source meter. The self-healing conductivity retention of the hydrogel was also analyzed by EIS monitoring of the hydrogel before and after self-healing using Gamry potentiostat (reference 3000 ZRA, USA). The hydrogel cooling and heating profile was examined by Carl ZEISS (Axio Imager A2m, Germany) on Linkam LTS120 temperature and environmental control stage in three temperature stages (i) 25° C. to −30° C., (ii) −30-100° C., and (iii) 100-25° C. with a temperature surging rate of 10° C. The stratified end of hydrogel was placed on glass slide and covered with LTS120 glass cover slip to avoid water evaporation or spilling of organic matter on the focal point during the experiment. The stratified end is chosen to clearly study the boundaries of dissolution and reformation at various temperatures. Differential scanning calorimetry was conducted under nitrogen streaming at heating rate of 10° C. min 1 from 30° C. to −60° C. using NETZSCH DSC 404 F3 Pegasus, Germany. The percent weight loss of the hydrogel with and without ecoflex encapsulation was calculated through the equation: weight loss (%)=(W^{o}−Wn)/W^{o}×100, where Wo is the initial weight, and Wn is the weight at a given degradation time. The output performance was evaluated in an aluminum chamber equipped with a linear motor (LinMot) which provides periodical mechanical compression input (˜8 N force at a velocity of 1 ms⁻¹ and acceleration/deceleration of 1 ms⁻²). Keithley 6514 (input resistance=200 tera-ohms) was used for measuring transferred charges, output voltage, and short circuit current via a full-wave rectifier bridge. The software platform was built on the basis of LabVIEW. SHE-TENG was stored at −30° C. for 24 h to investigate the output performance at freezing state. For assessment of the effect of the aqueous state, the device was submerged in DI water for 24 h. Thermal images were acquired using FLIR 53-24° (FLIR Systems Inc., USA) and post-processed using FLIR Tools software (Version 6.4). For finger bending motion evaluation at various angles, the lower layer of ecoflex was prepared from polyethyleneimine (PEI) modified ecoflex (10 g ecoflex mixture of A and B+5 μL PEI). This sticky ecoflex layer helps to firmly adhere the device with skin, and real-time output voltage at different bending angle was calculated. To evaluate the self-healing characteristic of the finger bending angle monitoring SHE-TENG device, the induction layer was cut, and the performance was tested before and after healing. For hand tapping, the device was stretched to 200% using stretching mode of linear mode. All electrical output measurements were carried out in ambient conditions (room temperature, 22±1° C.; relative humidity, 50±3%).

One can see that preferred embodiments of the invention thus provide stretchable, transparent, solid hydrogel network of AA grafted with (GA) for autonomous healing is investigated. GA is a natural polysaccharide polymer comprised of 1,3-linked β-D-galactopyranosyl main chains with branches of galactose, rhamnose, glucoronic acid and arabinose residues. This cluster structure is enriched with intermolecular, intramolecular hydrogen bonding sites, non-bonding electron pairs, and dynamic covalent bonding sites cross-linked with acrylic acid via secondary ionic bonding through ferric ions. The combination of these overlapping interactions not only imparts fast autonomous self-healing of mechanical, optical, and electrical properties, but can also retain healing characteristics in both wet and freezing (−30° C.) states, due to their ability to switch between dynamic bonding and electrostatic diffusion-less healing interactions. The hydrogel induction layer develops a stable polarized interface with the electrification layer, utilizing covalent, secondary ionic, hydrogen bonding and lone pair electrostatic centers offering high charge delocalization density, achieving power density of 11.1 W m⁻² with peak current of 22.18 μA at the matching impedance of 9 MΩ, which overperforms all liquid, semisolid, solid based reported self-healable TENGs as shown in Table S1 [19,26−38]. Further, the device retains high power density of 7.28 W m⁻² (18.01 mA m⁻²) in aqueous and 7.04 W m⁻² (17.69 mA m⁻²) in freezing states. The device is highly sensitive to slight human skin dynamics, but invariable to frequency of dynamics and can charge Li—Cr 2032 battery in only 3.39 h via hand tapping, which is comparable to a conventional charging pattern. This diffusion-less approach of intrinsic switchable interactions simultaneously addresses the fast autonomous self-healing, resistance, durability-related issues associated with tribo-electrification devices and demonstrate its potential not only for ambient state robotics, sportswear, prosthetics but can also be extended to underwater, freezing environment power back-up, and cryogenics.

Herein, this limitation is overcome by introducing hydrogen bonding cluster and non-bonding electrostatic centers in solids to accelerate ion dynamics via more delocalization centers that can switch healing reformations at various physical states. As such, the matrix can retain fast autonomous self-healing characteristics in dry, aqueous, and freezing states via diffusion-less self-healing mechanism. The self-healable hydrogel renders a triboelectric nanogenerator on contact with skin with a power density of 11.1 W m⁻² at a matching impedance as low as 9 MΩ, retaining 7.28 W m⁻² in aqueous and 7.04 W m⁻² freezing states, which outperforms all the reported self-healable induction devices. This diffusion-less approach of intrinsic switchable interaction is promising for robotics, sportswear, all weather prosthetics, cryogenics, and harsh weather power back-up applications.

The exemplary embodiments are thus fully described. Although the description referred to particular embodiments, it will be clear to one skilled in the art that the invention may be practiced with variation of these specific details. Hence this invention should not be construed as limited to the embodiments set forth herein.

While the embodiments have been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

What is claimed is:

1. A self-healable hydrogel, comprising:
a) an acrylic acid (AA) polymer;
b) gum Arabic (GA) grafted on the AA to form AA-GA graft copolymer; and
c) ferric ions cross-linking the GA-grafted AA copolymer;
wherein the GA is imparted as a cluster molecule that mediates non-diffusionless bonding interaction in the hydrogel.

2. The self-healable hydrogel of claim 1, comprises intermolecular hydrogen bonding sites, intramolecular hydrogen bonding sites, non-bonding electron pairs, and dynamic covalent bonding sites.

3. The self-healable hydrogel of claim 1, wherein the hydrogel is adapted to be preserved at a temperature from −30° C. to 80° C.

4. A method of preparing a self-healable hydrogel, comprising the steps of:
a) dissolving acrylic acid (AA) in deionized water;
b) adding gum Arabic (GA) into solution of the AA;
c) adding ferric chloride hexahydrate as a cross-linker;
d) adding ammonium persulfate into the solution; and
e) heating the solution;
wherein the GA has a weight ratio of no more than 12 wt. % with respect of the AA.

5. The method of claim 4, wherein the ferric chloride hexahydrate has a weight ratio of no more than 3 wt. % with respect to AA.

6. The method of claim 4, wherein Step e) further comprises conducting heat treatment to the solution at 40° C. for two hours in oven.

7. A triboelectric nanogenerator, comprising:
a) a self-healable hydrogel according to claim 1;
b) an elastomer encapsulating the hydrogel; and
c) a tribopositive layer movable relative to the elastomer.

8. The triboelectric nanogenerator of claim 7, wherein the elastomer is made of silicon rubber.
